(19) United States
(12) Patent Application Publication
(10) Pub. No.: US 2005/0096926 A1
(43) Pub. Date: May 5, 2005

(54) Automated realty transfer

(76) Inventors: Steven Louis Eaton, Bruce Township, MI (US); William Edward Shannon II, Emmett, MI (US); Karen Linda Karam, Ray, MI (US); David Owen DeRees, Romeo, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 10/698,648

(22) Filed: Oct. 31, 2003

(51) Int. Cl. G06F 17/60

(52) U.S. Cl. 705/1

(57) ABSTRACT

A system and method for automating the transfer of real estate. A centralized server or servers are connected to a distributed computer network that is connected between a plurality of client computers. A real estate record is created on the centralized server and information is received on the server from a plurality of sources including real estate databases, computer input devices, facsimile equipment, and electronic mail systems. The centralized server is integrated with a multiple listing service wherein information can be automatically exchanged therebetween. Fax or email communications may include documents for storage on the server. The fax or email sender enters a record identifier wherein the server recognizes the record identifier and determines whether it matches an existing real estate record. If so, the server converts the document to digital form if necessary and saves it to the matching real estate record.

### CROSS-REFERENCES TO RELATED APPLICATIONS

Not applicable.

### FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates generally to data processing for business practices. More particularly, the present invention relates to a comprehensive automated method that integrates, secures, and disseminates information for facilitating the management of real estate transfers.

2. Description of the Related Art

Transfer of real estate, or realty, historically involved a series of disjointed, labor-intensive procedures. Real estate sales professionals, or Realtors®, often facilitate the traditional real estate transfer process by coordinating multitudes of complex, time-consuming tasks involved in all phases of the process—from pre-listing to post-closing of the particular real estate involved. The real estate transfer process is typically accomplished through an assortment of communication mediums that are not integrated and often not in digital form. In fact, Realtors® often find themselves carrying out a variety of manual tasks, for example, waiting by the facsimile machine to send or collect fax transmissions, driving all around town to drop off or pick up documents, and telephonically coordinating schedules of various parties involved in the process. In other words, the traditional process requires Realtors® to spend an inordinate amount of time actively managing mundane details, instead of spending time with more rewarding and value-added responsibilities like counseling their clients, marketing their properties, networking with other real estate professionals, and cross-selling real estate related services.

In response to this problem, numerous real estate project management software packages have been proposed. Unfortunately, such packages tend to present incomplete solutions in that they do not address all tasks within all phases of the real estate transfer process from pre-listing to post-closing. For example, some approaches focus on narrow aspects of the real estate transfer process such as calculating commissions or sharing real estate vendor information. Moreover, such packages are often stand-alone PC-based software that is loaded to run on computers of individual users. Unfortunately, such packages must be individually installed on each users PC, thereby increasing the cost of system deployment, upgrading, and maintenance. Additionally, such packages require a significant amount of costly training or rare user initiative to learn the program, which thereby discourages use. Furthermore, such packages require all parties and Realtors® to be computer savvy. Unfortunately, many parties to a real estate transaction—even some Realtors®—are not computer trained. Accordingly, such packages exclude participation by non-computer savvy people. Finally, such packages do not typically embrace the traditional real estate business model, but instead, attempt to replace well-known and established steps and procedures in the real estate transfer process, thereby leading to reluctance among users to try the software.

Moreover, a related problem involves the current inability to quickly and easily centralize a variety of documentation types and associate such documentation with respective records in a database via email and/or fax transmissions from multiple locations. Current systems and methods for receiving information from a fax transmission typically involve deciphering of embedded data or tags within the fax transmission according to a particular protocol. Moreover, such systems and methods typically require a server to cross-reference the sending fax telephone number with a list of preauthorized fax numbers, before admitting or processing the fax information. Thus, current systems and methods are dependent upon a particular transmission protocol and dependent upon storing a large number of pre-approved fax numbers. Other current systems and methods require a step of actually logging into the system and/or verification of system credentials in order to load documents.

From the above, it can be appreciated that attempts to automate real estate transactions are not fully optimized because such attempts do not provide a comprehensive approach to facilitating the entire real estate transfer process according to existing real estate industry business practices, wherein a real estate professional orchestrates all activities associated with the transfer. It can also be appreciated that attempts to automate the centralization of fax information are unnecessarily complex, necessitate the storage of large numbers of pre-approved fax numbers, and are sensitive to the type of transmission protocol used.

### BRIEF SUMMARY

According to the present invention, there is provided a system and method for automating at least some phases of a process of transferring real estate. The present invention is preferably centralized on one or more servers and is carried out over a distributed computer network that is connected between the servers and a plurality of client computers. According to the present invention, a real estate record is created on the server and information is received thereon from a plurality of sources including real estate databases, computer input devices, facsimile equipment, electronic mail systems, and the like. Preferably, some of the information is received from a real estate multiple listing service. The information is then associated to the real estate record using a record identifier that is associated with the real estate record, and is stored on the server in association with the real estate record.

In an embodiment of the present invention, information is received by receiving a fax communication from any fax source that is capable of contacting the server irrespective of a fax number of the fax source. In other words, the server need not recognize the fax number of the fax source. Moreover, the server includes software thereon that prompts a sender of the fax communication to input the record identifier into the fax source. Once the record identifier is input and recognized by the server, the server software is capable of converting the fax communication into a digital document that represents the information to be associated and stored. The server software then determines whether the input record identifier matches any of a number of real estate records that are stored on the server. If this determination is negative, then the digital document is discarded, but if it is positive, then the digital document is saved on said the server in accord with its matching real estate record.

In another embodiment of the present invention, information is received by receiving an email communication wherein the record identifier is entered in a subject line of the email communication. Software on the server determines whether the record identifier matches any of a number of real estate records that are stored on the server and discarding the email communication if not. If so, then, an attachment that is associated with the email communication is saved on the server in accord with its matching real estate record.

It is an object of the present invention to provide a system and method for automating real estate transfer wherein the system and method are integrated with a Realtor® based Multiple Listing Service (MLS), such that information can be automatically exchanged between the MLS system and the system of the present invention.

It is a further object of the present invention that the present invention be broker-centric such that a real estate broker controls access to the system, decides what business rules the system uses, restricts third-party participation in the real estate transfer process, and establishes calendar templates to be used by real estate agents in the employ of the real estate broker.

It is another object to provide a method and system that does not require participants to a real estate transaction to be computer proficient or even to have access to a computer. Rather, the method and system enable non PC savvy participants to actively participate in the automated transactions, simply by using a fax machine with which such participants are familiar.

It is still another object to provide a fax transmission and reception method that is capable of centralizing and routing fax documentation to a database record without having to decipher embedded tag information in the fax transmission or otherwise be dependent upon any particular transmission protocol. Rather, it is an object to provide method of prompting a fax sender to input a simple record identifier or document routing number that uniquely identifies a database record and then routing a fax from the fax sender to that database record or a storage location that is associated with that database record.

It is yet another object to provide an email transmission and reception method that is capable of centralizing and routing email documentation or attachments to a database record without having to decipher embedded tag information in the email transmission or otherwise be dependent upon any particular email transmission protocol. Rather, it is an object to provide method of recognizing a simple record identifier or document routing number that is entered in a subject line of the email and that uniquely identifies a database record and then routing the email or attachment from the email sender to that database record or a storage location that is associated with that database record.

It is a further object to provide a system and method of automating real estate transfer, wherein access to the system is based on different roles of users who use the system, wherein some users can masquerade as other users, and wherein usage is tracked using an audit trail function.

It is yet a further object to provide a system and method of automating real estate transfer wherein emails are automatically generated in response to the occurrence of certain events and advertisements can be automatically generated in the form of an email transmission by assembling different fields of information from a real estate record.

These objects and other features, aspects, and advantages of this invention will be more apparent after a reading of the following detailed description, appended claims, and accompanying drawings.

### BRIEF DESCRIPTION OF THE SEVERAL VIEWS OF THE DRAWINGS

Features and advantages of the present invention will become apparent to those skilled in the art from the following description with reference to the drawings, in which:

FIG. 1 is a diagrammatic overview of a system environment according to an embodiment of the present invention;

FIG. 2 is a diagrammatic representation of a multi-tiered system according to the embodiment of FIG. 1;

FIGS. 3-8B depict a database constructed in accordance with an embodiment of the present invention;

FIG. 9 is a graphical flow diagram of a direct upload version of a Digital Document Management process of the present invention;

FIG. 10a depicts a graphical flow diagram of a fax transmission version of the Digital Document Management process;

FIG. 10b depicts a flow diagram of the fax transmission version of the Digital Document Management process;

FIG. 11a illustrates a graphical flow diagram of an email transmission version of the Digital Document Management process;

FIG. 11b illustrates a flow diagram of the email transmission version of the Digital Document Management process;

FIG. 12 is an example of a navigation page for the World Wide Web in accordance with an embodiment of the present invention;

FIG. 13 is an example of a listing input page for the World Wide Web in accordance with an embodiment of the present invention;

FIG. 14 is an example of a user interface page for the World Wide Web in accordance with an embodiment of the present invention; and

FIG. 15 is a flowchart depicting a process for managing real estate transactions in accordance with an embodiment of the present invention.

### DETAILED DESCRIPTION

In general, the present invention provides a system and method for managing real estate transactions. The system and method allows brokers and managers to manage real estate transactions within their realty company(ies). It additionally allows agents working for those companies to collect, process and control data and documents relating to real estate transactions in an efficient, cost-effective manner. It further allows other parties with an interest in the real estate transactions to have role-based access to specific transactions or portions of the data thereof.

In accordance with a preferred embodiment of the present invention, different users of the system perform different functions depending on their role. For example, brokers manage, maintain, and monitor information in the system related to their brokerage, which may consist of one or more offices. Managers of offices maintain and monitor information related to their office. Agents create property listings (aka real estate records), maintain client lists, monitor and enter information related to the property listings, and maintain and control access to the property listings. Brokers and managers are also agents, and can act in every way as an agent. Administrative personnel (staff) aid brokers and managers through data entry into the system and by other clerical efforts. Likewise, agent assistants do similar clerical work for agents. Buyers and sellers of real estate can access data from the system that is related to their properties. Other third parties (mortgage, title, survey companies etc.) can enter and access data for listings to which they have been associated.

It is envisioned that the preferred embodiment will exhibit higher performance, flexibility, and maintainability compared to prior art systems. Performance is based on how quickly data is selected, utilized and converted into a visually acceptable format, and transmitted to the client. In the preferred embodiment, the system will provide acceptable performance through the use of adequate servers, proper indexing of data, proper bandwidth utilization, and optimized visual elements. Flexibility allows for adaptation as certain business rules change. This is done through the use of stored procedures 40 in databases 36 that can be easily accessed and modified as required. This is additionally accomplished through the use of specialized data structures within the present invention database. This is further done through the use of ActiveX COM+ (Component Object Model) elements that can be accessed by various applications including without limitation, a system for maintaining listings, and Internet and Intranet applications. Maintainability encompasses ease of installation, deployment, and updates. It allows for people skilled in the art, other than the original development team, to easily perform modifications and enhancements to the system. In the preferred embodiment, the system is browser based and is maintained entirely at a server, and no updates must be moved to the user's computers. Updates made on the servers could be done via any type of network connection.

I. Overview

The description below will occasionally refer specifically to certain drawing figures as will be indicated. Generally, however, the detailed description may discuss the present invention without specific reference to any single drawing figure.

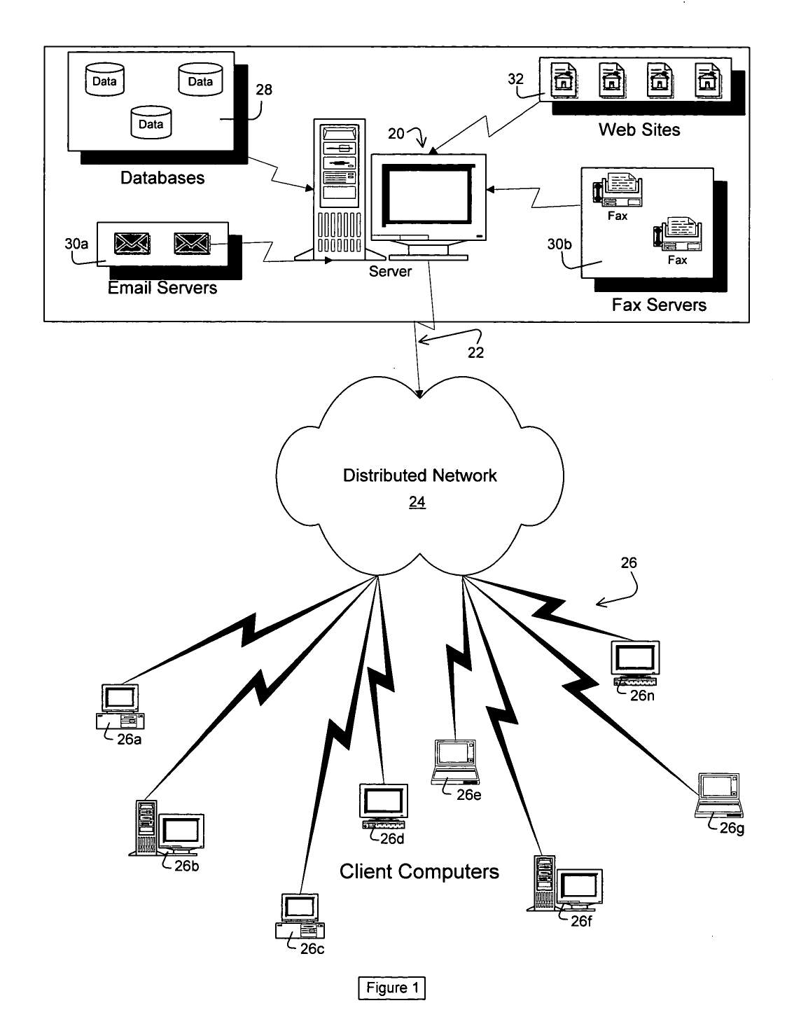

Referring now specifically to the drawing figures, there is illustrated in FIG. 1 a schematic representation of an environment in which the system and method of invention may be implemented. In the preferred embodiment, the environment in which the system and method of invention will run consists of a server 20 that communicates via a communication channel 22 with a distributed computer network 24.

The distributed network 24 will preferably contain a client tier 26 that is defined by a plurality of individual networked terminals, workstations, or computers 26a-26n. The distributed computer network 24 consists of any combination of a number of network systems. For example, it may consist of a combination of local area networks (LAN), wide area networks (WAN), intranets, or the Internet. The preferred embodiment makes use of the Internet due to the Internet's wide adoption and familiar interface.

Computers 26a-26n are associated with users of the present invention and method of invention. The number of computers in the diagram is not intended to put any limit on the number of real or potential users represented. Users of the present invention include brokers, managers, agents, staff and assistants of the realty company; clients of the brokers, managers, and agents of the realty company, and all third party contacts associated with the realty company. It is envisioned that many configuration variations of the client computers 26a-26n may provide the required performance, reliability and consistency necessary for the system and method of invention. In one embodiment, an exemplary one of the computers 26a-26n includes a Pentium processor above 400 MHz with 64 MB RAM, a 56K modem, a video monitor with at least 800.times.600 pixels and 16 bit color. Further, the example computer 26a-26n is running Windows 98 and Microsoft Internet Explorer 5.0 or higher with JavaScript enabled.

Multiple users may share the same computer. A multiple of users can use the invention at the same time from the same or a variety of locations. The computers 26a-26n allow users to communicate with and access data on the server 20 through the distributed network 24 and communication channels 22. The communication channels 22, whether wired or wireless, are well known and therefore not further described herein. It is also envisioned that users can communicate with the server 20 by a direct connection to the server.

Additionally, the server 20 hosts multiple databases 36, business objects, and web sites that can be characterized as a data tier 28, a business tier 30 partially defined by email and fax servers 30a, 30b, and a web tier 32. It is envisioned that the preferred configuration of the server 20 will consist of one or multiple servers as necessary to achieve the desired performance from server 20. Multiple servers can be linked in such a way so as to provide for greater stability and performance of the present invention through the distribution of processing and memory.

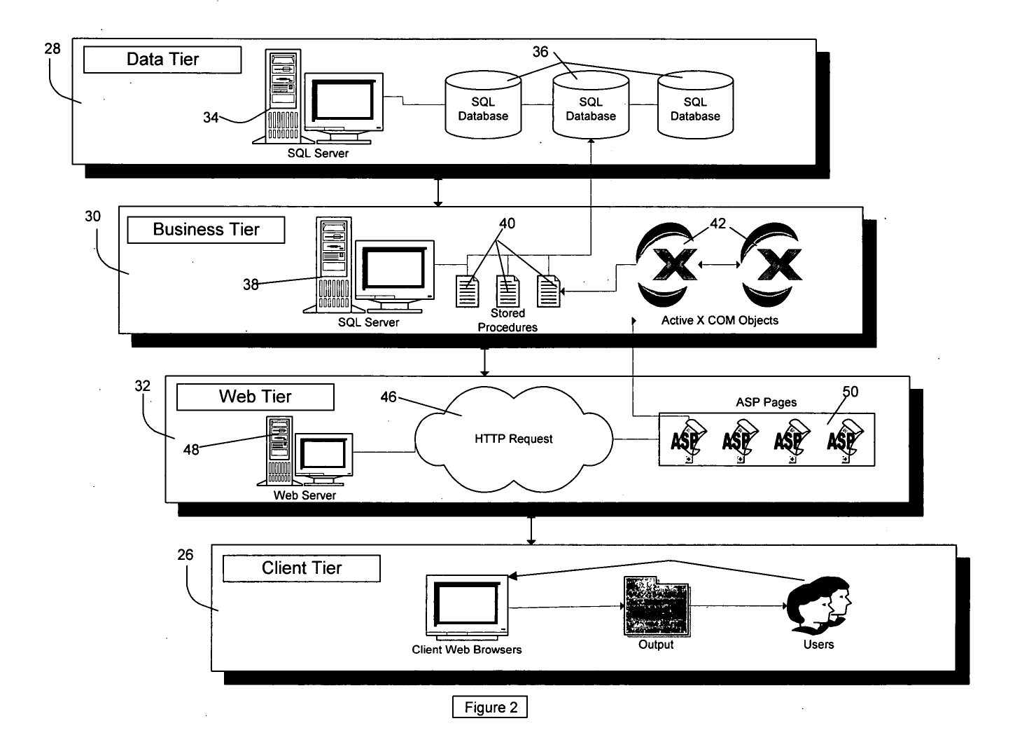

Referring now to FIG. 2 there is illustrated a representation of the preferred embodiment of present invention. The data tier 28 runs a database server (preferably Microsoft SQL Server 2000) and hosts a plurality of databases 36. The business tier 30 includes a business server 38, stored procedures 40 in the databases 36, and ActiveX COM+objects 42 that make use of those stored procedures 40. The business tier 30 contains the core data functions of the system including retrieving requested data and updating existing data. The business tier 30 also receives data into the system via the email and fax servers 30a, 30b that may be integrated within the business server 38 itself or separate therefrom as shown.

In the preferred embodiment, the client tier 26 utilizes a browser 44, preferably Microsoft's Internet Explorer. The client tier 26 sends Hypertext Transfer Protocol (HTTP) requests 46 to the web tier 32. A web server 48, preferably using Microsoft's Internet Information Server (IIS) software, processes those requests 46 and returns appropriate ASP pages 50. After processing the ASP pages 50, the web tier 32 returns to the client tier 26 the necessary information for the browser 44 on the client tier 26 to create the visual interface for the user.

In a preferred embodiment, the architecture of the server 20 is multiple servers in order to increase stability and enhance performance. For example, each server which comprises server 20 would consist of a PENTIUM.RTM. 4 2.5 GHz processor (available from Intel Corporation, 2200 Mission College Boulevard, Santa Clara, Calif. 95052), 1 GB RAM and hard disk non-volatile memory large enough to support web files, an operating system, several applications and several databases 36. Preferably, WINDOWS 2000.RTM. software (available from Microsoft Corporation) is the server operating system. It is envisioned that the web sites are created in HTML language utilizing VISUAL STUDIO.RTM. software version 6.0 (available from Microsoft Corporation) and remote access is facilitated by Microsoft's Remote Desktop Connection and GlobeSCAPE's CuteFTP 2.8. MICROSOFT's SQL SERVER.RTM. 2000 software (available from Microsoft Corporation) is the database engine used by the present invention, and is also used to maintain relationship diagrams for the various databases 36 of the present invention. MICROSOFT INTERNET INFORMATION SERVER.RTM. IIS software version 5.0 (available from Microsoft Corporation) allows developers to customize the web sites. RightFax Enterprise Fax Manager version 8.5.0.137 is used to process incoming faxes.

Still referring to FIG. 2, in a preferred embodiment the server 20 is configured as a combination of three servers, two of which are configured with a Pentium 4 2.5 GHz with 1 GB RAM, a hard disk large enough to support web files and an operating system such as Windows 2000; and the third which is configured with a PENTIUM.RTM Pro 200 with 256 MB RAM, and a hard disk large enough to support an enterprise fax manager and an operating system such as Windows 2000. The first server, such as the data server 34, associated with the server 20 runs a Microsoft SQL Server 2000 installation for housing multiple databases 36 including, without limitation, the present invention, and other smaller databases. The second server, such as the web server 48, associated with the server 20 runs Microsoft Internet Information Server (IIS) 5.0, stores the ASP pages 50 (and/or HTML pages), and processes the HTTP requests 46. The third server, such as the business server 38, associated with the server 20 receives and processes fax and email documents into the system of the present invention. In yet another embodiment, additional servers may be incorporated into server 20 to further increase performance and stability.

II. Open Connectivity and External System Integration

In a preferred embodiment, the system and method of invention can be integrated with Realtor® Multiple Listing Services (MLS). Various MLS systems provide documentation that contains the information required to interface to the MLS system of interest. Custom interfaces are developed to extract data from the data tier, format the data according the MLS system specifications, and make that data available to the MLS system on a regular basis.

Additionally, the MLS system may provide a method or methods for data to be extracted from the MLS system and incorporated into the present invention databases. In one embodiment the MLS system may include an Application Program Interface (API) that the present invention can use to retrieve data from the MLS system. In another embodiment, the MLS system may provide an Internet-based interface into their data. The present invention can retrieve data pages from the MLS system (using the Microsoft XML Document Object Model 3.0), parse the data page, and incorporate the data.

It is envisioned that standard development tools will be used in conjunction with the present invention and method of invention. For example, in the preferred embodiment Microsoft SQL Server 2000 Enterprise Manager can be used for the development and maintenance of the database and stored procedures. Microsoft Visual Studio 6.0 or Microsoft Visual Basic 6.0 can be used for the creation and compiling of the ActiveX COM+objects. Microsoft Visual Interdev 6.0 may be used for the development of HTML and ASP web pages within the application. GlobeSCAPE's CuteFTP 2.8 may be utilized to distribute the various ActiveX COM+ objects and web pages to the proper locations on the server.

Further examples include Adobe Acrobat version 4.0 and Adobe Distiller 4.0 for creating manuals available from within the present invention.

In the system and method of invention, the databases will be able to interact with an email system. In a preferred embodiment, Microsoft SQL Server 2000 will be used, which contains stored procedures that can interact with a Mail Application Program Interface (MAPI) compliant email server. In a preferred embodiment, the email server that is contained within Microsoft Outlook 2000 is such an email server. These tools are used to bring documents into the system via email.

Another example includes RightFax Enterprise Fax Manager version 8.5.0.137 for processing incoming faxes. The faxes are made available to a process within the scope of this invention that is described herein further below.

Still further examples include Microsoft's XML Parser 3.0 which includes a component that can be used to retrieve the resulting HTML code of web pages, given a web page Uniform Resource Locator (URL).

III. Data Creation and Maintenance

The data architecture supports a database server, database connectivity, data conversion, data archiving and auditing capabilities. The database server preferably utilizes Microsoft SQL Server 2000 as the database engine for the present invention. Microsoft's Active Data Objects (ADO) version 2.7 is used to establish database connectivity between business objects and the databases. Preferably the ODBC DSN parameters including name and password are maintained within a database connection business object. SQL Server Enterprise Manager and SQL Server Query Analyzer are used for maintaining a data dictionary, primary and foreign key definitions, triggers, and stored procedures.

Data conversions can automatically reformat existing data in external formats such as Microsoft Access and Microsoft Excel for compatibility with the present invention and method. Alternatively, data conversions can require manual re-entry for all current listing data.

It is noted that while the exemplary description herein refers to specific individual databases, formats, records, and fields, those skilled in the art will readily appreciate that various modifications and substitutions may be made thereto without departing from the spirit and scope of the present invention.

IV. Security

The security context of users is set based on several criteria and can be modified from ASP page to ASP page. Some pages that relate to marketing aspects of the system and method of invention do not require any level of permission. Other portions of the system require the user to log in, and the level of access granted is determined by the user's relationship to the owner of the data. Tokens are created and assigned to users at different junctures to track the user's identity, the user's relationship to data owners, and the user's participation in given real estate transactions as determined by the property listing agent. These tokens are used in conjunction with business rules in the requested ASP web page to determine which business objects are used and what data is visible to the user.

Preferably the present invention and method for invention use a role-based security method. When access is established for a given user, a recognized role within the system is assigned to the user. In addition, listing agents can assign specific users within given roles as participating in a given real estate transaction.

In a preferred embodiment, there are three key aspects considered within the security model as follows: (i) User identification/authorization and tokenization; (ii) Determining a user's relationship to the data owner; (iii) and Determining the user's participation in the real estate transaction. A combination of custom security components, database tables, and application logic is used to tokenize a user and determine permission levels.

The ASP application is configured to allow anonymous access. This allows anyone to request any ASP web page. However, most ASP web pages additionally check for the proper tokens to exist. Without the proper tokens, the user is redirected to a login ASP web page. The few pages that do not require tokens are marketing pages that provide information to existing and potential users of the present invention.

At an ASP web page that contains a login option, the user must enter a set of credentials such as UserName and Password that will uniquely identify the user within the system environment.

The UserName and Password are passed to a business tier object that looks for matching UserName and Password information in the user database. If the combined UserName and Password is not found in the user database, authentication is terminated and a resulting message is passed to the web tier. The web tier provides a visual message to the client tier informing the user of the rejected login and provides an opportunity for the user to log in again.

If the combined UserName and Password are located in the user database, the user is authenticated and the following tokens are created: (i) a token representing the user's unique ID within the system environment; (ii) tokens representing the user's relationship to a broker, manager, and agent; and (iii) a token representing the user's role. An exemplary method for creating the tokens is to create them as session variables within the IIS/ASP framework. An additional exemplary method is to create a unique ID for the user session, and use the unique ID as a key into a database that contains the token values for the user session.

The tokens are time sensitive, based on the configuration of time parameters within the web tier, and expire after a certain period of inactivity by the user. In the preferred embodiment, the time period is set (but not limited) to 60 minutes.

If the tokens do not exist, either because they were never created or because they have expired, the next HTTP request from the user will be handled as if the user had never been authenticated, i.e.; the web tier will provide a visual message to the client tier informing the user that no authenticated login exists and will provide an opportunity for the user to log in again.

After the user is authenticated and tokenized, the user is allowed into the present invention. The tokens are used in the web tier to determine the visual interface provided to the client tier.

Once having been authenticated and tokenized, the security model follows two branches: (1) Functions to which a user is granted access by virtue of the user's role. These functions are outside the realm of any real estate transaction or property listing. For example, a user with the assigned role of “broker” is allowed to masquerade as another user. In another example, a user with the assigned role of “client” does not have access to add new listings to the present invention. (2) Property-related functions to which a user is granted access by virtue of the user's role, the user's relationship to the data owner, and the user's assigned participation within the real estate transaction. For example, a user with the assigned role of “agent” can schedule showing appointments on properties listed by another agent when both agents have the same manager. In another example, a user with the assigned role of “surveyor” can only view the property information for listings to which the property listing agent(s) have assigned the given user as the associated surveyor.

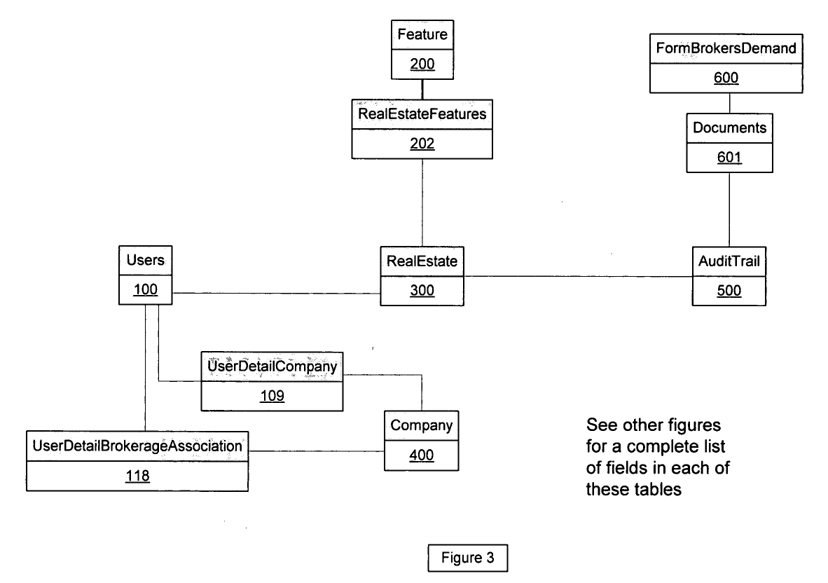

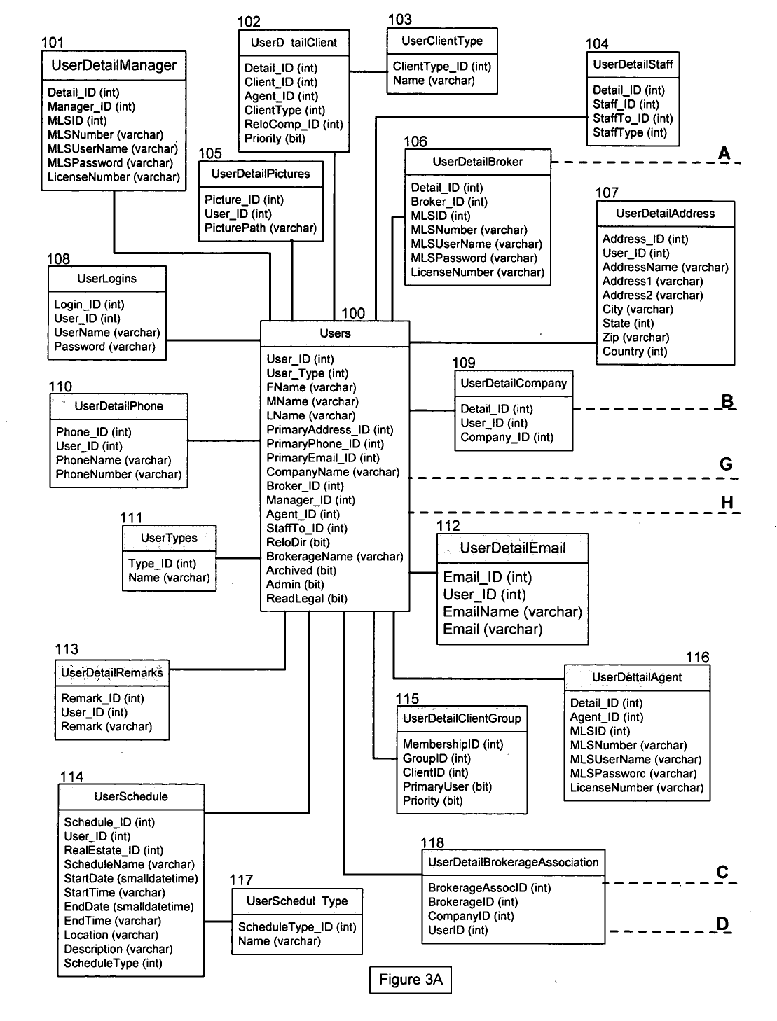

Referring again to the drawing figures, FIG. 3A shows how roles are defined within the present invention and method of invention. A data entry for a new user is entered into the Users table 100. The user is assigned a role from the list of available roles in the UserTypes table 111. A user can be assigned only one role at any given time.

It is envisioned that several roles will be defined, and that additional roles may be added in the future. The various roles correspond with the various people who interact within the confines of a real estate transaction. At a minimum, the following roles are defined. Brokers are those who are licensed as real estate brokers, who own a real estate company or multiple real estate companies, each of which will have at least one office. Managers are responsible for the operation of one office and have authority to act on the broker's behalf within that office. Agents are those in the field responsible for obtaining listings of homes and properties, and for attracting buying customers of those homes and properties. Brokers and Managers, by virtue of their authority and credentials, also act as agents. Staff members aid Brokers or Managers in clerical duties. Assistants are hired by Agents to assist in clerical duties. Clients and Client Groups are those who are customers of Agents for the purpose of purchasing real estate, selling real estate, or both. Third Parties are those who participate in the real estate transaction and who may need access to certain information related to that transaction, but who otherwise work primarily outside of the scope of the present invention and method of invention. These Third Parties include (but are not limited to) Attorneys, Title Companies, Relocation Companies, Mortgage Companies, Appraisers, Survey Companies, Home Inspection Companies, Sign Companies, Pest Control Companies, Co-Op Brokerages, Municipalities, Advertising Companies, and Insurance Companies.

An additional role of System Administrator also exists, but is separate from the UserTypes. This is based on a flag that is set within the Users table. Any user could be assigned as a system administrator. However, this is typically reserved for those skilled in the art and with the technical knowledge to understand the affect of various configuration changes upon the present invention.

Security maintenance is provided from within the present invention and method. System Administrators can enter data to support new MLS companies and brokerages. A broker, manager or agent can grant or remove access for any user within the broker's, manager's, or agent's sphere of influence. For brokers this would include managers, agents, staff, assistants, and clients and client groups. For managers this would include agents, staff, assistants, and clients or client groups within the office managed by the manager. For agents this includes a given agent's clients, client groups, and assistants. Third Party contacts may also be granted access to listings within a brokerage or be cut off from those listings as the broker sees fit.

An additional security function is that provided to users assigned to the role of broker or manager (or broker's or manager's staff) allowing the broker or manager to masquerade as one of the users under the broker's or manager's realm of influence (managers, agents, staff, assistants, and clients). This allows the broker or manager to understand what is visible to users that are assigned other roles, and allows the broker or manager to process clerical work for others if necessary.

To access this function, the broker or manager proceeds to a visual interface where the broker or manager is presented a list of users as whom the broker or manager is allowed to masque. Upon selecting one of the presented users, the broker or manager is presented a visual interface as if the user being masqueraded had just logged on. The broker or manager has the option at any point in time to change the masquerade to another user or to turn off the masquerade function and continue as his or her own self.

The act of starting and ending a masquerade session, along with any data modifying action, is captured and maintained in an audit file. Thus one user can act as another, but the present invention tracks such usage.

For an example, an agent could request a staff member of the office of which the agent is an employee to make certain changes to a property listing within the present invention. That function may be available to only the property listing agent. The staff member can masquerade as the agent and thereby gain access as the agent.

V. Databases

In the preferred embodiment, the memory of the database server stores a multiplicity of databases. It is envisioned that the databases are created utilizing MICROSOFT SQL SERVER 2000.RTM (available from Microsoft Corporation). The databases contain data relating to users, real estate listings, real estate features, third party companies, audits, and documents.

It is envisioned that the user related databases contain information regarding all people who have or may need access into the present invention including (but not limited to) name, address(es), phone number(s), email address(es), company affiliation, broker/manager/agent affiliation, login credentials, remarks, and schedule. Real estate listing databases preferably consist of property address, listing information, photographs and image file locations, documents and document file locations, showing and open house information, real estate features, advertisement information, and associated third party contacts. Real estate features databases preferably consist of lists and groupings of features specific to various MLS companies that can be selected to further describe a property listing (aka real estate record). Company databases preferably consist of information regarding various third party companies with whom the brokerages do business and can include (but is not limited to) company name, address(es), phone number(s), email address(es), company type (role), and user affiliations. Digital document management (DDM) databases preferably consist of information related to the inbound processing, storage, real estate relationship, and management of digital documents. Audit databases preferably consist of information regarding various auditable events happening in the present invention including (but not limit to) user login and logout, masquerade start and end, creating and/or editing of listing data, sending of automatic emails, and viewing of listing-related documents.

In a preferred embodiment, the databases are used in a relational arrangement so that they relate to one another by way of fields that store common data. Referring again to the drawing figures, a system in accordance with the subject disclosure preferably has data as shown in FIGS. 3-8B. Referring to FIG. 3, there is shown an overall view of the databases illustrating the major connections between various fields 100-601 which can be used as a roadmap for understanding FIGS. 3A-8B, which illustrate the databases in finer detail. Each of FIGS. 3A-8B are related to each other by dashed matching lines A-A through F-F. The dashed matching lines allow FIGS. 3A-8B to be assembled to illustrate the interrelationship between the input fields shown within each figure. Adjacent to each variable name is the data type of the variable.

FIG. 3A illustrates the fields as they can be input for Users 100, User Detail Manager 101, User Detail Client 102, User Client Type 103, User Detail Staff 104, User Detail Pictures 105, User Detail Broker 106, User Detail Address 107, User Logins 108, User Detail Company 109, User Detail Phone 110, User Types 111, User Detail Email 112, User Detail Remarks 113, User Schedule 114, User Detail Client Group 115, User Detail Agent 116, User Schedule Type 117, and User Detail Brokerage Association 118. UserClientType 102, UserTypes 111, and UserScheduleType 117 are predefined and pre-loaded by System Administrators. All users of the present invention are entered into Users 100 and are assigned a User Type 111. User addresses are entered into UserDetailAddresses 107. User phone numbers are entered into UserDetailPhone 110. User email addresses are entered into UserDetailEmail 112. The network location for user pictures is entered into UserDetailPictures 105. If the user has been granted login credentials to the present invention, the credentials are stored in UserLogins 108. Some users have remarks entered about them, which are stored in UserDetailRemarks 113. If the user is assigned the user type of Broker, the user is also stored in UserDetailBroker 106 where further broker-related information can be entered. If the user is assigned the user type of Manager, the user is also stored in UserDetailManager 101 where further manager-related information can be entered. If the user is assigned the user type of Agent, the user is also stored in UserDetailAgent 116 where further agent-related information can be entered. If the user is assigned the user type of Staff, the user is also stored in UserDetailStaff 104 where further staff-related information can be entered. If the user is assigned the user-type of Client, the user is also stored in UserDetailClient 102 and assigned a further type of Buyer, Seller, or Client Group. If the client is identified as a member of an existing client group, the client will also be stored in UserDetailClientGroup 115. If the user is a third party contact, the user is also stored in UserDetailCompany 109 in association with the company to which the contact belongs. As brokers establish third party company and contact relationships, the relationship between broker, company, and contact is stored in UserDetailBrokerageAssociation 118. As items are added to a user's schedule, the items are entered into UserSchedule 114.

FIG. 3B illustrates the fields as they can be input for User Detail Brokerage 119, User Relo Types 120, User Detail Buyer Relo 121, and User Detail Seller Relo 122. When a brokerage is entered into the present invention, detailed brokerage information is stored in UserDetailBrokerage 119. UserReloTypes 120 are predefined and entered by System Administrators. UserDetailBuyerRelo 121 contains information regarding buyer relocation clients. UserDetailSellerRelo 122 contains information regarding seller relocation clients.

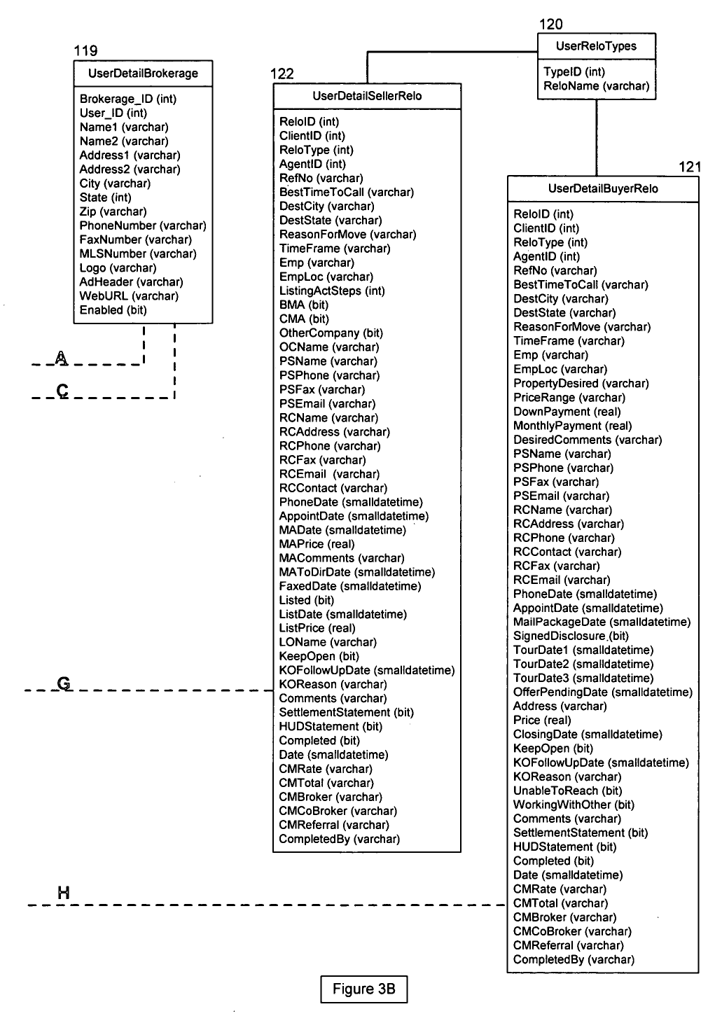

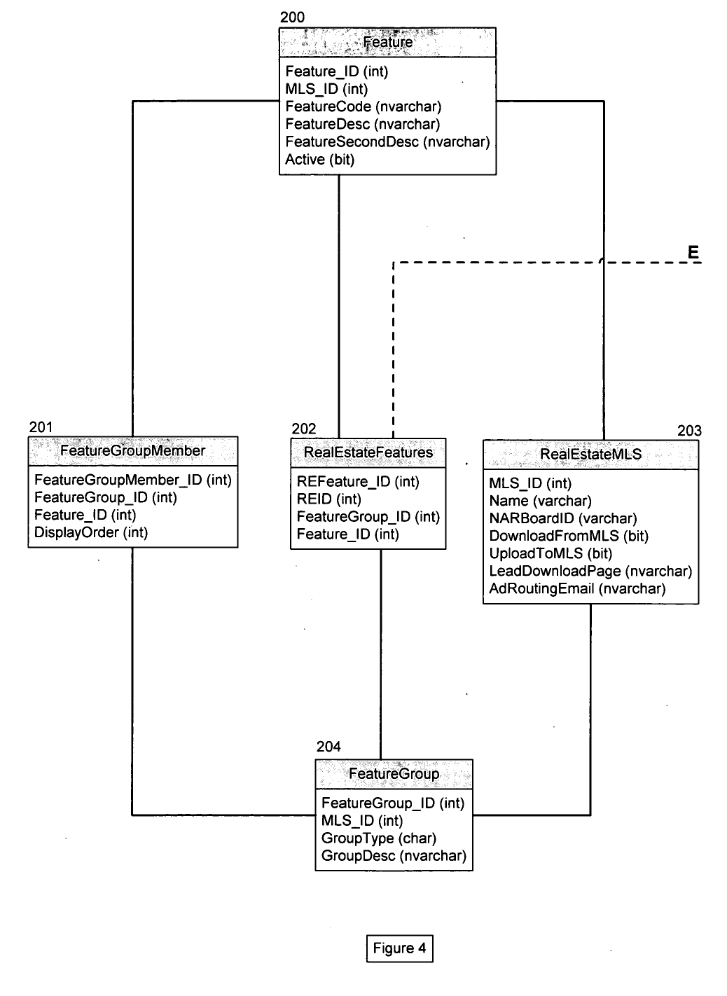

FIG. 4 illustrates the fields as they can be input for Features 200, Feature Groups 204, Feature Group Members 201, Real Estate Features 202, and Real Estate MLS companies 203(a). Even before brokerages can be entered into the present invention, the System Administrators must enter at least one MLS company into the present invention. RealEstateMLS 203(a) contains information and switches regarding each MLS company in the present invention. Each MLS company can create a list of features available to be used on listings handled through the MLS company. Those features are stored in Feature 200 and associated with the MLS company. Features are further divided into various groups for use in different parts of the present invention. Feature groups are identified and stored in FeatureGroup 204. With the features and groups now identified in the present invention, the relationship identifying the groups to which the features belong is stored in FeatureGroupMember 201. A given feature can belong to more than one group, but a given feature cannot belong to any group more than one time. When features are selected on a listing, the relationship between the feature and its associated group, along with the property listing to which it is related is stored in RealEstateFeatures 202.

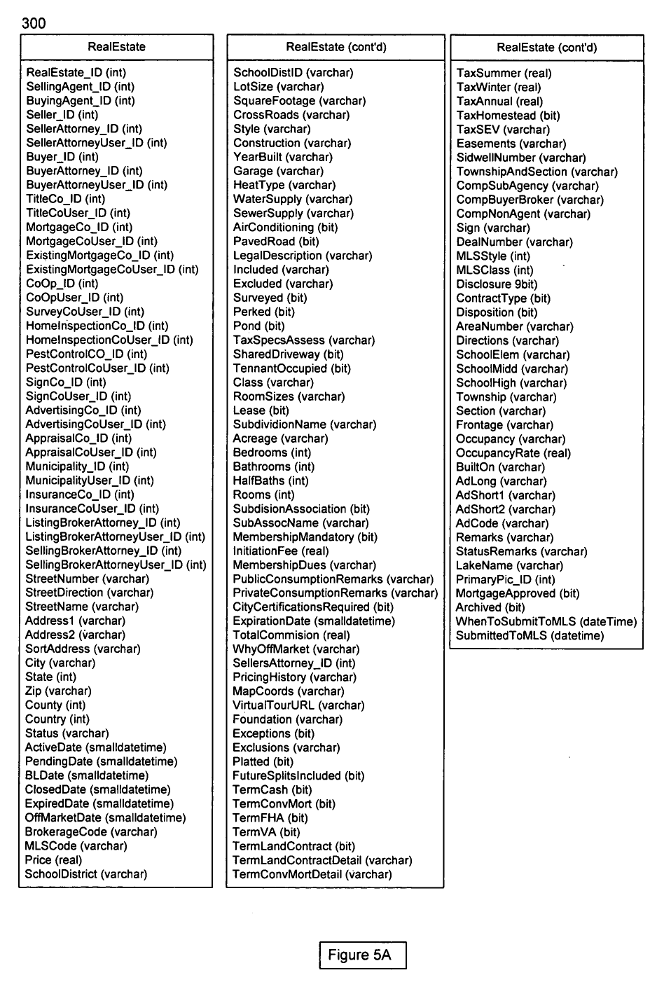

FIG. 5A illustrates the fields as they can be input for RealEstate 300. Each record in this table represents a listing. This illustration will be referred to in following illustrations.

FIG. 5B illustrates the fields as they can be input for Real Estate Appointments 301, Real Estate Pictures 302, Real Estate Closing 303, Real Estate Open House 304, Real Estate Deal Data 305, Real Estate Appointment Types 306, Real Estate Advertisements 307, Real Estate Feedback 308, Real Estate Showing Instructions 309, Real Estate Mortgage 310, Real Estate Interested Buyer 311, and Real Estate School Districts 312. RealEstateAppointmentTypes 306 are predefined and stored by System Administrators. For example, one appointment type is a Showing. RealEstateSchoolDistricts 312 contain information regarding school districts including school district names and codes. When a listing is entered in RealEstate 300, additional data can now be associated to the property listing. The property school district is selected from RealEstateSchoolDistricts 312. Pictures are stored in image files and the network address for those image files is entered in RealEstatePictures 302. Open houses are stored in RealEstateOpenHouse 304. RealEstateShowingInstructions 309 contains necessary information to successfully show the property. Information regarding advertisements placed to promote the property listing is stored in RealEstateAdvertisements 307. Showings and other appointments are stored in RealEstateAppointments 301 with an appointment type assigned from RealEstateAppointmentTypes 306. If an agent advises one of the agent's clients of the property, that advisement is entered in RealEstatelnterestedBuyer 311. When a buyer is found, deal data is stored in RealEstateDealData 305, the closing information is stored in RealEstateClosing 303, and the process of approving a mortgage can be tracked by data stored in RealEstateMortgage 310.

FIG. 5C illustrates the fields as they can be input for Real Estate MLS Style 313, Real Estate MLS Class 314, Real Estate MLS Brokerage 315, Real Estate Rooms 316, Real Estate Room Types 317, and Real Estate Room Floor Covering 318; also the relationship between these tables and Users 100, RealEstateMLS 203(b), and RealEstate 300. As mentioned previously, System Administrators work with MLS companies to gather the information required in order to add the MLS company to the present invention in RealEstateMLS 203(b). The MLS company will have standard codes used for classification of listing data that must also be collected and entered into the present invention by System Administrators. RealEstateMLSStyle 313 contains codes that define the style of real estate property. For example, styles might include “1.5 Story Masonry” or “Vacant”. RealEstateMLSClass 314 contains codes for listing classification. For example, listings may be classified as “Residential” or “Commercial”. RealEsateRoomType 317 contains the various rooms recognized by the MLS company. For example, room types might include “Living Room”, “Kitchen”, or “Bedroom”. RealEstateRoomFloorCovering 318 contains the various room floor coverings recognized by the MLS Company. For example, floor coverings might include “Carpet”, “Wood”, or “Vinyl”.

Continuing with FIG. 5C, when a broker and brokerage is entered into the present invention, the broker is entered into the Users table 100. The broker (and therefore the brokerage as illustrated in the relationship displayed in FIG. 3B 119) is also associated with a MLS company, and the association is entered into RealEstateMLSBrokerage 315. The relationships between brokers and managers and agents are created as the various users are entered into the system, and the relationships are maintained within the Users table 100. Agents enter listings into RealEstate 300, and attach listing classifications as defined in RealEstateMLSStyle 313 and RealEstateMLSClass 314 and associated with the proper MLS company. Additionally, property room information can be attached to the property listing and is stored in RealEstateRooms 316. As rooms are described and entered, room types and floor coverings must be selected from those available in RealEstateRoomType 317 and RealEstateRoomFloorCovering 318 and associated with the proper MLS company.

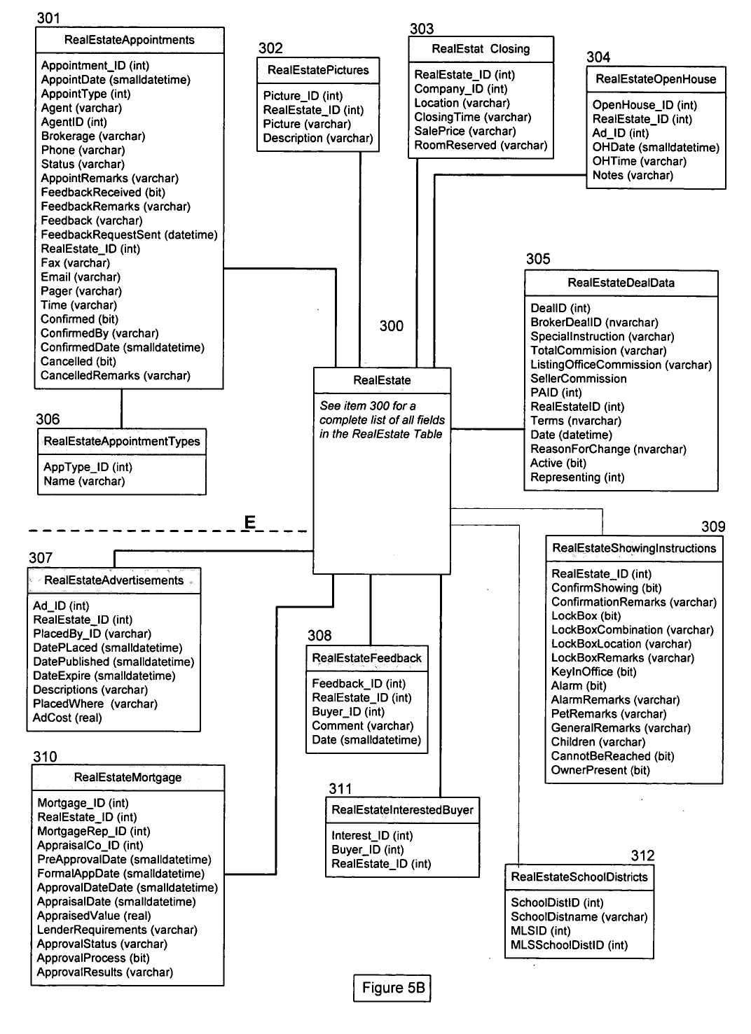

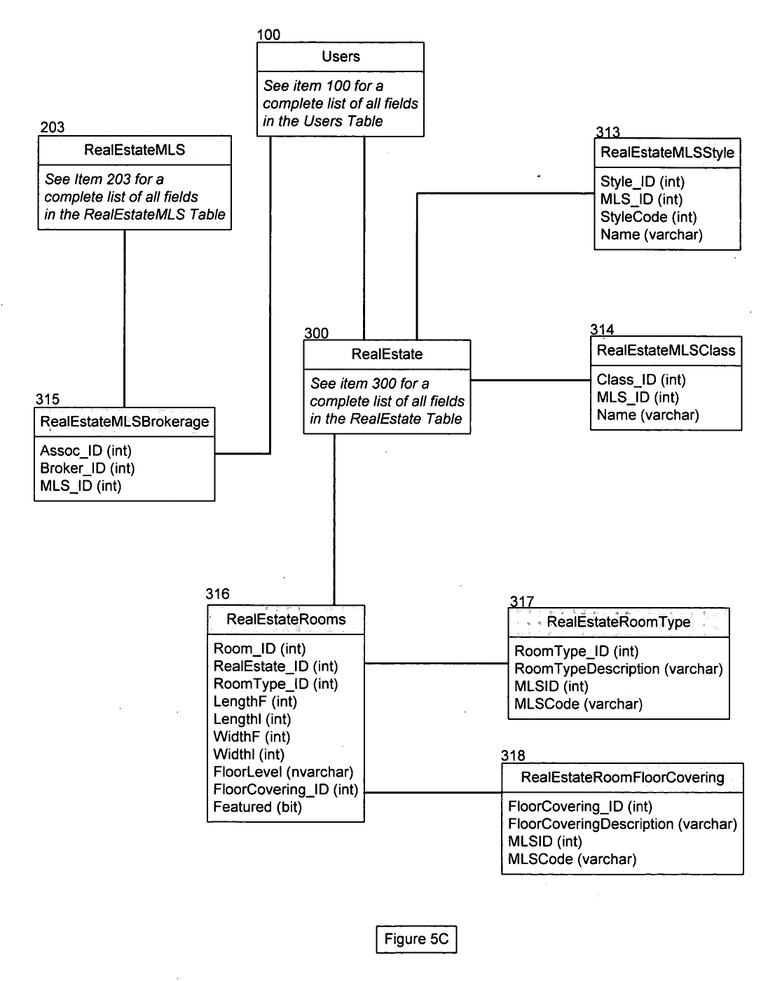

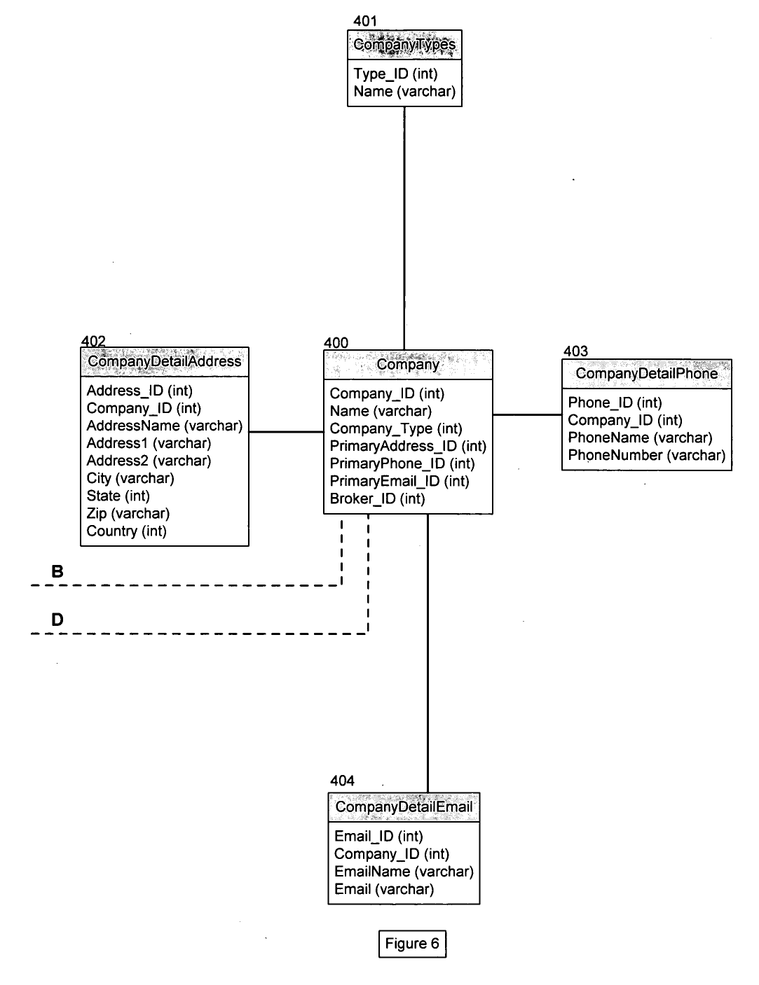

FIG. 6 illustrates the fields as they can be input for Company 400, Company Types 401, Company Detail Addresses 402, Company Detail Phone 403, and Company Detail Email 404. CompanyTypes 401 are predefined and entered by the System Administrators. For example, company types might include “Legal Company”, “Title Company”, or “Municipality”. A Company 400 is a third party company with which a broker does business. The broker selects from companies that already exist in the present invention, or enters a new company into the present invention. Once the company has been entered, company addresses can be entered into CompanyDetailAddresses 402, company phone numbers can be entered into CompanyDetailPhone 403, and company email addresses can be entered into CompanyDetailEmail 404.

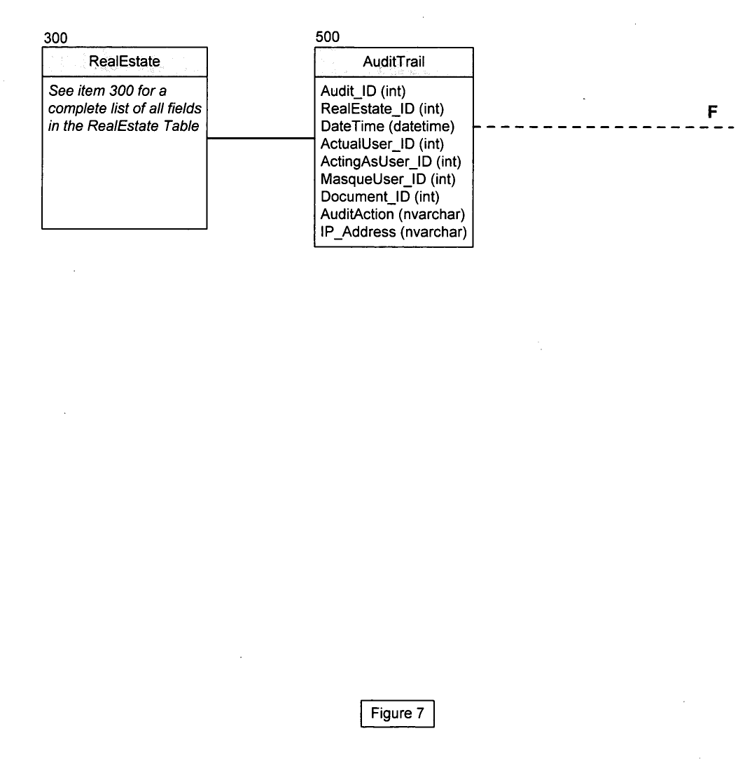

Referring now to FIG. 7, the fields as they can be input for AuditTrail 500 are illustrated. Audit trail records are generated by the present invention as users go about their tasks within the present invention. Often those tasks will be related to a listing within the system as found in RealEstate 300. Sometimes those tasks will be related to viewing or emailing a document attached to a listing (via dashed lines F-F). Audit trail records are available for reporting purposes as related to a specific user, or as related to a specific listing.

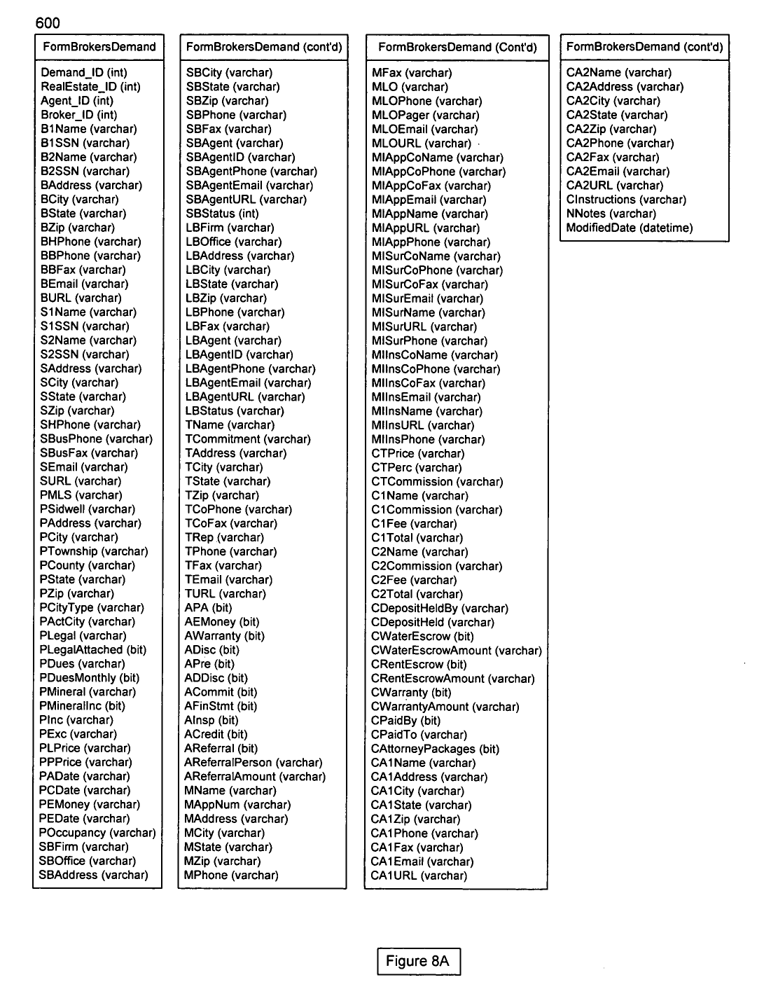

FIG. 8A illustrates the fields as they can be input for FormBrokersDemand 600. The Broker's Demand Form is created as a seller and buyer reach an agreement. It contains contact information regarding many of the parties involved in the real estate transaction as well as additional information. The Broker's Demand Form is associated to a specific listing.

FIG. 8B illustrates the fields as they can be input for Documents 601, Document Types 602, Fax Processing 603, and MailStore 604. These tables constitute the core of the Digital Document Management (DDM) portion of the present invention. DocumentTypes 602 are predefined and entered by System Administrators. For example, document types might include “Word Document”, “Excel Spreadsheet”, “Adobe Acrobat”, or “Other”. When a document is added to the present invention, the document is stored in a document storage area on the server, and an entry is created in Documents 601 that includes both the network address of the document, and a reference to the property listing to which the document is associated. The document entry is also associated with one of the type from DocumentTypes 602. FaxProcessing 603 is a record of the faxes sent to the present invention. Mailstore 604 is a temporary storage location used in the process of taking documents that have been emailed to the present invention and attaching those documents to listings.

VI. Primary Inputs

Primary inputs are put into the databases according to functional requirements, security, business rules, and user actions as follows.

A. MLS Entities

Multiple Listing Service (MLS) entities in the system represent MLS companies to which brokerages belong. Within the confines of the present invention, MLS entities provide an object to which settings can be applied that would affect every brokerage belonging to the MLS entity. For example, a setting indicating whether or not listings can be uploaded to the MLS system can be established on this object. If the process has been developed allowing listings to be uploaded to the MLS, it would apply to all brokerages in the present invention affiliated with the MLS entity.

Exemplary business rules for MLS entities will be as follows. MLS Name must be entered. Other information may be included including (but not limited to) National Association of Realtors (NAR) Board ID, indication if downloads are possible from the MLS, MLS customized download page, indication if uploads are possible to the MLS, email address for ad copy.

For security, MLS entities can be updated only by System Administrators. System Administrators have several available actions including the ability to Add a new MLS entity, Edit an existing MLS entity, and Delete an MLS entity. MLS entities can be added or edited at any time. MLS entities can be deleted only if no brokerages exist in the present invention using the MLS entity.

B. Brokerages

Brokerages in the system are real estate companies, owned and operated by a broker, who belong to an MLS entity, whose purpose is to contract with customers to sell properties, and who attract other customers to buy properties. Brokerages generally hire sales representatives (agents), though it is also possible that the broker is the only agent. Brokerages may have an organizational structure whereby the broker oversees one or more managers who in turn oversee agents.

Exemplary business rules for brokerages will be as follows. The brokerage name, address, city, state, zip code, and user ID of the primary broker must be entered to save a brokerage. Optionally phone number, fax number, and an identification value by which the MLS recognizes this brokerage may be entered. If the brokerage has a predefined graphic logo, this may be loaded into the present invention for use on ad layouts and for branding purposes. A brokerage can only be affiliated with one MLS entity, and must be affiliated with one MLS entity.

For security, brokerages can be updated by System Administrators, and selected information may be updated by brokers. System Administrators have several available actions including Add a brokerage, Edit a brokerage, and Delete a brokerage. Brokers have only the ability to Edit a brokerage. Deleting a brokerage removes all real estate listings listed by that brokerage, and removes all managers, staff, agents, assistants, clients, client groups, and the broker from the system.

C. Brokers

Brokers in the system are the owners of real estate companies in the present invention. They control which of their employees are allowed access in the present invention, and control several “brokerage-wide” settings. Brokers can only be entered by System Administrators.

Exemplary business rules for brokers will be as follows. The primary broker of a brokerage must be entered at the same time the brokerage is entered. A broker is affiliated with one brokerage. First name and last name must be entered to save a broker. The broker should be assigned a unique system user name and password. Zero or one or more addresses, phone numbers, and/or email addresses may be entered for a broker. If one or more addresses are entered, one address will be considered primary. If one or more phone numbers are added, one phone number will be considered primary. If one or more email addresses are entered, one email address will be considered primary. A picture of the broker can be stored within the present invention. Brokers can create subordinate users within the present invention including managers, agents, staff, assistants, clients and client groups. Brokers can establish a brokerage association with third party companies existing in the present invention or by entering new third party companies. Brokers can further establish an association with selected third party contacts affiliated with those third party companies either by selecting third party contacts that already exist in the present invention or by entering new third party contacts. Brokers can edit and maintain third party company and/or third party contact information until such time as one of the third party company's affiliated contacts has logged into the present invention for the first time. Brokers can maintain listing information for any listing within the brokerage as if the broker was the property listing agent. Brokers can delete listings from the present invention. Brokers can masquerade as any of the broker's employees or employee clients as long as the person being masqueraded has been assigned login credentials. Brokers have access to particular reports that report on aspects of the brokerage as a whole. Brokers can add items to their own schedule. Brokers can act in every way as a manager. Brokers can act in every way as an agent.

For security, broker information can be updated only by the broker himself/herself or by the broker's staff. Brokers are only deleted from the present invention if the entire brokerage is being deleted, and can only be deleted by System Administrators.

D. Managers

Managers in the system oversee a subset of the users in the present invention affiliated with a brokerage. Typically a manager would oversee one office of a multi-office brokerage. Managers in many ways act as the local broker of the office, however managers cannot modify third party company/contact associations.

Exemplary business rules for managers will be as follows. A manager will be affiliated with one broker. First and last name must be entered to save a manager. The manager should be assigned a unique system username and password. Zero or one or more addresses, phone numbers, and/or email addresses may be entered for a manager. If one or more addresses are entered, one address will be considered primary. If one or more phone numbers are added, one phone number will be considered primary. If one or more email addresses are entered, one email address will be considered primary. A picture of the manager can be stored within the present invention. Managers can create subordinate users within the present invention including agents, staff, assistants, clients, and client groups. Managers can maintain listing information for any listing listed by the manager or one of the manager's agents as if the manager was the property listing agent. Managers can delete listings from the present invention. Managers can masquerade as any of the manager's subordinates or subordinate clients as long as the person being masqueraded has been assigned login credentials. Managers have access to particular reports that report on aspects related to the manager's sphere of influence. Managers can add items to their own schedule. Managers can act in every way as an agent.

For security, manager information can be updated by the manager's broker, the broker's staff, the manager's staff, or by the manager himself/herself. Managers can be added and deleted only by brokers. Deleting a manager does not remove the subordinate users of the manager.

E. Agents

Agents in the system are the primary users responsible for entering and maintaining listings within the present invention. Agents can receive assistance from their broker, their manager, staff, or their assistant(s) in accomplishing clerical tasks.

Agents are primarily responsible for contracting with clients to sell property, and for aiding clients in purchasing property. As such, agents take on several sub-roles including (but not limited to) listing agent (the agent listing the property), peer agent (another agent within the brokerage of the property listing agent), showing agent (the agent inspecting a property with a prospective buyer), and selling agent (the agent whose client is the purchaser of the property).

Exemplary business rules for agents will be as follows. Where any business rule is more restrictive for an agent than for a broker or manager, the rules for brokers or managers will take precedence for users assigned the role of broker or manager. An agent will be affiliated with one broker and possibly one manager. If the agent is not affiliated with a manager, the broker will act as the manager. First and last name must be entered to save an agent. The agent should be assigned a unique system username and password. Zero or one or more addresses, phone numbers, and/or email addresses may be entered for an agent. If one or more addresses are entered, one address will be considered primary. If one or more phone numbers are added, one phone number will be considered primary. If one or more email addresses are entered, one email address will be considered primary. A picture of the agent can be stored within the present invention. Agents can create subordinate users within the present invention including assistants, clients, and client groups. Agents can add items to their own schedule.

As a listing agent, an agent can enter and maintain all information for a real estate listing. This includes (but is not limited to) maintaining property information, features, room information, listing-related dates, advertising information, showing and open house information, photographs, and forms and documents. The agent will have access to new documents entered for the property, and will establish access rights that determine which users will be able to view those documents. The agent will control the association of others to the property listing, including selecting third party contacts from the list of broker-approved third party contacts to associate to individual listings.

Within a given real estate company office, it is financially beneficial if both the seller of the property and the buyer of the same property go through the same office. Therefore, it is to the financial benefit of the office for agents within the office to cooperate in the buying and selling of properties. Peer agents have permission to view property information on all properties listed through the same office (that is, the agents are under the same manager). Peer agents have permission to create and edit showing appointments. Peer agents may add documents to the property listing.

An agent who wishes to inspect a property with a client requests and schedules a showing through the property listing agent. The showing agent is granted access to a specific subset of listing information for the property. After the showing, the showing agent is requested to enter feedback on the showing.

The agent whose client purchases the property is considered the selling agent. The property listing agent associates the selling agent to the property listing. Prior to making that association, the selling agent has no access to the property listing information except as the selling agent may also fulfill another role related to that listing, such as listing agent, peer agent, or showing agent. The selling agent can review the property information of the property listing. The selling agent can associate the buyer to the property listing, selecting the buyer from the selling agent's client list. The selling agent can review and edit a subset of the Broker's Demand form, view documents to which the selling agent has been granted view rights, and can add additional documents to the property listing. If, for any reason, the property listing agent chooses to remove the selling agent's association with a listing, the (former) selling agent immediately loses all access privileges to the property listing, except as the agent may still fulfill another role related to that listing such as listing agent, peer agent, or showing agent.

If an agent is deleted from the system, all references to that agent will be replaced with a “deleted user” token.

For each agent an MLS ID, MLS username and MLS Password can be entered. This information uniquely identifies the agent to the MLS, and allows the agent to gain access to the MLS system via the present invention if required.

For each agent the agent's state-issued real estate license number can be entered. This uniquely identifies the agent within a given state. Others can use this within the present invention to look up the agent.

For security, an agent can be updated by the agent's broker or manager, the broker's or manager's staff, or the agent himself/herself. Users have several available actions including the ability to add a new agent (except that agents cannot add themselves), edit an existing agent, or delete an agent (except that agents cannot delete themselves).

F. Staff

Staff members in the system are users in clerical roles that assist either brokers or managers. Brokers and managers may hire staff members who can be directed to execute the details of many of the functions for which brokers and managers are responsible. Among these functions are various functions of the present invention. For example, a staff member may be directed by the broker or manager to add an agent to the system. The details of the function “add an agent” include (but are not limited to) gathering the agent's name, address, phone number and email address; logging into the present invention, entering the agent into the system, assigning login credentials to the agent, notifying the agent that access has been granted to the present invention, and informing the agent of the agent's access credentials.

Because staff members may be requested by their broker or manager to execute any function in the present invention available to the broker or manager, staff is granted the same access privileges as their broker or manager. It is understood that any function executed by a staff member is being executed under the direction of the staff member's broker or manager. As such, the broker or manager assumes full responsibility for those actions.

Exemplary business rules for staff will be as follows. Only brokers or managers can enter staff members into the present invention. Staff members will be considered owned by the user who enters them into the system, i.e., brokers enter brokerage staff and managers enter office staff. A single user in the present invention cannot be considered staff to more than one user. First and last name must be entered to save a staff member. The staff member should be assigned a unique system username and password. Zero or one or more addresses, phone numbers, and/or email addresses may be entered for a staff member. If one or more addresses are entered, one address will be considered primary. If one or more phone numbers are added, one phone number will be considered primary. If one or more email addresses are entered, one email address will be considered primary. Staff members cannot create subordinate users within the present invention. Staff members can add items to their own schedule.

For security, staff members can be added and deleted only by the broker or manager that owns the staff member. Staff members may be updated by the broker or manager that owns the staff member, or by the staff member himself/herself.

G. Assistants

Assistants in the system are users in clerical roles that assist agents. Agents may hire assistants who can be directed to execute the details of many of the functions for which agents are responsible. Among these functions are various functions of the present invention. For example, an assistant may be directed by the agent to add a listing to the system. The details of the function “add a listing” include (but are not limited to) gathering listing-related information, logging into the present invention, and entering the property listing into the system.

Assistants are not considered part of the real estate company personnel. Assistants are considered an employee of the agent.

Because assistants may be requested by their agent to execute any function in the present invention available to the agent, assistants are granted the same access privileges as their agent. It is understood that any function executed by an assistant is being executed under the direction of the assistant's agent. As such, the agent assumes full responsibility for those actions.

Brokers and managers can act in every way as agents. Therefore, brokers and managers can also have assistants.

Exemplary business rules for assistants will be as follows. Only agents can enter assistants into the present invention. Assistants will be considered owned by the user who enters them into the system. A single user in the present invention cannot be considered an assistant to more than one user. First and last name must be entered to save an assistant. The assistant should be assigned a unique system username and password. Zero or one or more addresses, phone numbers, and/or email addresses may be entered for an assistant. If one or more addresses are entered, one address will be considered primary. If one or more phone numbers are added, one phone number will be considered primary. If one or more email addresses are entered, one email address will be considered primary. Assistants cannot create subordinate users within the present invention. Assistants can add items to their own schedule.

For security, only the agent that owns the assistant can add the assistant to the system. Assistants can be deleted by either the agent that owns the assistant, or by the broker or manager that owns the assistant's agent. Assistants can be updated by the agent that owns the assistant, the broker or manager that owns the assistant's agent, or by the assistant himself/herself.

H. Clients and Client Groups

Clients and Client Groups in the system are those customers of real estate companies who are working with agents with the intent of either selling or buying a real estate property. Agents generally attempt to cultivate a relationship with the clients in order to create current and future business with those clients. As such, the agents have an interest in keeping their clients informed of a variety of aspects of the real estate transaction, and informing the clients of the amount of effort the agent is expending on the client's behalf. A Client Group provides a method for contacting several clients as one entity.

Brokers and managers can act in every way as agents. Therefore, brokers and managers can also have clients and client groups.

Exemplary business rules for clients and client groups will be as follows. Only agents can enter clients and client groups in the present invention. Clients and client groups will be considered owned by the user who enters them into the system. First and last name must be entered to save a client. A client group name must be entered to save a client group. The client or client group should be assigned a unique system username and password. Zero or one or more addresses, phone numbers, and/or email addresses may be entered for a client or client group. If one or more addresses are entered, one address will be considered primary. If one or more phone numbers are added, one phone number will be considered primary. If one or more email addresses are entered, one email address will be considered primary. A client group must be entered prior to entering the clients who are members of the client group. The agent's broker and manager can see the agent's clients and client groups. Other agents cannot see the agent's clients and client groups. Clients and client groups cannot create subordinate users within the present invention. Clients and client groups can add items to their own schedule. If a client or client group is deleted from the system, all references to that client or client group will be replaced with a “deleted user” token.

For security, only the agent that owns the client or client group can add the client or client group to the system. Clients and client groups can be deleted by either the agent that owns the client or client group, or by the broker or manager that owns the client or client group's agent. Clients and client groups can be updated by the agent that owns the client or client group, by the broker or manager that owns the client or client group's agent, or by the client or client group himself/herself.

I. Third Party Companies

Third party companies in the system are companies with whom a realty company does business. These include (but are not limited to) law firms, title companies, mortgage companies, survey companies, appraisal companies, pest control companies, home inspection companies, sign companies, advertising companies, and municipalities. This can include other realty companies as Cooperative Brokerages.

Exemplary business rules for third party companies will be as follows. Company Name and Company Type must be entered to save a company. Zero or one or more addresses, phone numbers, and/or email addresses may be entered for a company. If one or more addresses are entered, one address will be considered primary. If one or more phone numbers are added, one phone number will be considered primary. If one or more email addresses are entered, one email address will be considered primary. Brokers establish associations with companies within the present invention. As agents associate third parties with a listing, the agent may select only companies with whom the agent's broker has created an association. Brokers can add new company associations or remove existing company associations at any time. Once a company has been entered into the present invention, it is shared among all brokerages in the present invention, regardless of who first entered the company.

For security, only brokers can enter new companies in the present invention. Any broker that has an established association with a given company may edit the given company's information until any contact of the given company logs into the system and accepts the user agreement. From that time forward, only contacts of the given company may edit the company's information. Companies are not deleted from the present invention, though the situation may occur where the company has no association with any brokerage.

J. Third Party Contacts

Third party contacts in the system are employees of third party companies who have been entered as a user of the present invention. Brokers not only establish associations with third party companies, but also with specific contacts (people) within those companies.

Exemplary business rules for third party contacts will be as follows. Contacts must be associated to a third party company that already exists in the present invention. First and last name must be entered to save a contact. The contact should be assigned a unique system username and password. Zero or one or more addresses, phone numbers, and/or email addresses may be entered for a company. If one or more addresses are entered, one address will be considered primary. If one or more phone numbers are added, one phone number will be considered primary. If one or more email addresses are entered, one email address will be considered primary. Brokers establish associations with contacts of third party companies with whom the broker has already established an association. As agents associate third parties with a listing, the agent may select only contacts with which the agent's broker has created an association, only from companies with whom the agent's broker has created an association. Brokers can add new contact associations or remove existing contact associations at any time. Once a contact has been entered into the present invention, that contact is shared among all brokerages in the present invention, regardless of who first entered the company. If a contact is deleted from the system, all references to that contact will be replaced with a “deleted user” token. Contacts may edit the information of the third party company to which they are associated.

For security, only brokers can enter new contacts in the present invention. Any broker that has an established association with a given contact may edit the given contact's information until that contact logs into the system and accepts the user agreement. From that time forward, only the contact himself/herself may edit the contact's information. Contacts can be deleted by brokers prior to when the contact first logs in and accepts the user agreement. After the contact logs in and accepts the user agreement, only system administrators may delete the contact.

K. Listings

Listings are a contract with a client to list their property with the real estate office that employs the client's agent. Listings are owned by the office and can be edited by only the property listing agent (or the agent's assistant), the agent's broker, the agent's manager, or the broker's or manager's staff. Listings are entered into the present invention after the property listing contract is signed. If listings are to be uploaded to the MLS system, listings will be entered without corresponding MLS numbers. After the property listing has been successfully entered into the MLS system, the assigned MLS number will be retrieved from the MLS system and added to the property listing in the present invention. Listings will be linked to the present invention home page for every user who is associated to the property listing. For each listing an unlimited number of pictures and documents can be associated.

Exemplary business rules for listings will be as follows. To save a listing the following must be entered: selling client, listing agent, listing expiration date, listing active date, listing status, property ID, street name, city, state zip code, country, county, selling price, school district, and MLS style. In addition, if automatic uploading to the MLS is enabled, the time and date as to when the property listing should be uploaded is required. (Additional information may be required in order for the property listing to be valid in the MLS system.) Each listing must have a selling agent as the selling agent provides the link to the brokerage and MLS. Listings have at most one of each of the following type of users associated with the property listing: listing agent, selling agent, seller, seller attorney, buyer, buyer attorney, title company user, mortgage company user, existing mortgage company user, co-op broker user, survey company user, home inspection company user, pest control company user, sign company user, advertising company user, appraisal company user, municipality user, insurance company user, listing broker attorney, selling broker attorney. However, one user can fill more than one user type. For example, one user can be the property listing agent, the selling agent, and the seller. Each property listing is assigned a unique record identifier or identification number. This record identifier becomes known as the Document Routing Number (DRN) for Digital Document Management (DDM).

In addition to the detailed information that can be entered for a listing, other types of information can be attached to a listing. This includes (but is not limited to) pictures, showing information, open house information, advertisement information, and documents. A listing must exist in the present invention prior to attaching any of this supplemental information. For the purposes of adding, editing, or deleting the property listing, this information is considered part of the property listing.

Listings have a status that may be set to any of the following states. Active indicates a listing for a property currently on the market and available. Pending is a property on which a transaction is currently taking place. If the transaction does not complete for any reason, the property listing may again become active. A Closed listing has had a completed transaction. The property is now under new ownership. Expired listings went past the property listing expiration date without having a selling transaction. Off-Market listings were once active but have been removed from the market without being sold. 72 Hour Contingency listings have a current contingency transaction.

Changing the status of a listing to Pending allows Deal Data to be entered and modified. If the status is returned to Active without Deal Data having been entered, Deal Data cannot be added to the property listing until the property listing is again Pending. However, once Deal Data has been added to a listing, it is always available to be modified (for those who have proper access).

Listings can be archived. This prevents the property listing from being included in most selection lists and reports, thereby allowing users to concentrate on only current listings. Archiving a listing also prevents it from being edited. Archived listings can be specifically included in certain queries. Archived listings can be unarchived which will return the property listing to a normal state.

For security, only the property listing agent (or the agent's manager or broker or staff masquerading as the property listing agent) can add new listings. Only the property listing agent or the property listing agent's manager or broker or staff can edit the property listing. Agents other than the property listing agent who are employed at the same office (peer agents) can add and edit showing information on the property listing. Brokers and managers can delete listings or archive listings. Any agent, manager or broker within the property listing agent's brokerage can view the property listing while its status is Active. Certain associated third parties can view the property listing. The buying and selling clients can view the property listing. Clients to whom the property has been advised by their agent can view the property listing.

There are two particular subsets of listing data that can be viewed under certain circumstances that do not require login access to the present invention. (1) When a showing is entered into the present invention, and the showing agent's email address is provided, the showing agent will receive via email a URL to a web page that displays certain listing information, including certain information related to showings. The showing agent does not have to be a system user or have login credentials in order to view this page. (2) While viewing a listing an agent, manager, or broker can send an email to anyone. The email contains a URL to a web page that displays certain listing information. The recipient of the email does not have to be a system user or have login credentials in order to view this page.

L. Pictures

Pictures are files of various formats that contain information which, when translated in accordance with the rules of the format used, can produce an image in the visual interface of the present invention. Such files are commonly known as image files. Exemplary formats include JPG, GIF, TIFF, PNG, and BMP. In the preferred embodiment, the format used will be one that is readily displayed in a browser at the client tier.

Pictures are used in three places within the present invention. (1) Brokers, managers, and agents can enter pictures of themselves that are then used for branding purposes, i.e., the picture is displayed in a way that associates the broker, manager, or agent with certain aspects of information within the present invention. (2) Pictures (or image files) can be entered in the present invention consisting of brokerage logos or other branding or advertising graphics. (3) The most common use of pictures is to provide visual information regarding the subject property of a listing.

The size and number of the image files must be considered in determining storage requirements for the server and bandwidth usage in sending data from the web tier to the client tier. In the preferred embodiment, brokerage and branding logos are limited to 200 kilobytes (200 K) in size, while agent and property pictures are limited to 100 kilobytes (100 K) in size.

Pictures are loaded to the present invention using the following process:

1. The user creates the picture (or image file) using any means they wish. Exemplary method for creating pictures include (but are not limited to) scanning pictures, creating a picture using a computer program, or using a digital camera. The user stores the picture in a network location accessible to the computer used for accessing the present invention.

2. The user logs into the present invention and navigates to the visual interface where a picture may be loaded to the present invention.

3. The user enters the location and name of the picture file, either by directly entering the name or by browsing the network and selecting the proper file.

4. The file is sent via the distributed network to the web server 48. The file is validated for file size and file type. If either the file size or file type does not match the required parameters, the file is rejected and the user is notified.

5. If the file is accepted, it is currently residing in the memory of the web server 48. A storage location for the file is selected that is dependent upon the object to which the file is being associated (user, brokerage, or listing). A random file name is generated and is verified to insure that it doesn't already exist.

6. The image file is stored in the selected storage location with the generated file name.

7. The fully qualified storage location and generated file name is entered into the database in association with the appropriate object.

8. When these images are needed, the storage location and file name stored in the database are used to retrieve the image file.

Exemplary business rules for user pictures will be as follows. Users will only have one picture associated with them at any time. New pictures can be uploaded, but they will override the earlier pictures. Only agents, brokers, and managers can have pictures associated with them.

Exemplary business rules for brokerage logos and graphics will be as follows. A brokerage will have only one picture associated with it at any time. New pictures can be uploaded, but they will override the earlier pictures.

Exemplary business rules for listing pictures will be as follows. A listing can have an unlimited number of pictures associated with it. If no pictures are associated with a listing, a default “No Image” picture will be displayed. Pictures will be ordered in the order in which they are loaded to the system. The visual interface that displays primary listing information will provide a method for scrolling through the pictures. Each picture can have a caption associated with it. One picture for a listing may be designated as the primary picture. The primary picture will default to being the first picture displayed on the visual interface that displays primary listing information. The primary picture designation may be moved at any time to any other picture associated with the property listing. If a listing has only one picture, that picture is the primary picture by default.

For security, a user's picture can be loaded only by users who have access to edit the user in question. Only System Administrators can load brokerage logos. Pictures associated with a listing, as well as captions and primary picture designations, can be loaded by anyone with access to edit the property listing.

M. Advertisements

Advertisements in the system consist of information about advertisements placed to promote a listing. This information includes (but is not limited to) who placed the advertisement, the date it was placed, the date published, the date it expired, a description of the advertisement, and the cost of the ad. Reports can be generated using this information to analyze advertisement effectiveness and expense.

Exemplary business rules for advertisements will be as follows. Advertisements must be attached to listings. Publication date must be entered to save advertisement information.

For security, only users who have access to edit the property listing can add, edit, view and delete advertisements.

N. Open Houses

Open houses are events when the listed property is made available for the public to inspect.

Exemplary business rules for open houses will be as follows. Open houses must be attached to listings. Date and Time must be entered to save an open house. Entering an open house in the present invention will automatically add an item to the property listing agent's schedule.

For security, only users who have access to edit the property listing can add, edit, view and delete open houses.

O. Showings

Showings in the system are appointments made between agents and potential buyers of a property. The showing agent contacts the property listing agent to establish a mutually agreeable date and time for the showing, and to acquire the means to gain access to the property. The showing agent meets the potential buyer at the property and inspects the property with the potential buyer. The showing agent later provides feedback to the property listing agent regarding various aspects of the showing including (but not limited to) the potential buyer's response, the condition of the property, and the likelihood of future interest by the potential buyer.

Exemplary business rules for showings will be as follows. Showings must be attached to listings. Date and time for the showing must be entered to save the showing. If an email address is entered for the showing agent, the showing agent will automatically receive notice via email of the entry of the showing, confirmation of the showing, or cancellation of the showing. If the showing is confirmed, the notice sent to the showing agent will include a copy of the Seller's Disclosure and the Lead-Based Paint Disclosure if such documents have been loaded into the present invention for the property listing. If the property listing agent has an email address stored in the present invention, the property listing agent will automatically receive notification via email of the entry of the showing, confirmation of the showing, cancellation of the showing, and the entry of feedback from the showing. If feedback has not been entered within 48 hours after the scheduled showing time, and if the showing agent's email address was entered, the showing agent will receive a reminder via email that feedback is requested. Within the email notification received by the showing agent will be a link to a feedback entry interface. Use of this interface does not require the showing agent to log into the present invention, nor does it require the showing agent to have any login credentials. Showings cannot be deleted, but can be cancelled.

For security, only the property listing agent, the property listing agent's manager or broker, or other agents under the same manager as the property listing agent (peer agents) can add, edit, or view showings. Showing agents can add feedback through a special feedback entry interface, but only if the entry point has been provided to the showing agent.

P. Buyer Advisement

If an agent is reviewing a property listing, and if the agent has a client whom the agent believes may be interested in the property listing being reviewed, the agent can advise the client of the property listing.

Exemplary business rules for buyer advisements will be as follows. Only agents who have the same manager as the property listing agent (peer agents) may advise listings to their clients. If the client has an email address on file within the present invention, the client will receive an automatic email notification that the client's agent has advised a new property to him. The property listing will be added to the list of listings available for the client to review when the client logs into the present invention.

For security, only the property listing agent, the property listing agent's broker or manager, or other agents who work for the same broker as the property listing agent may advise properties to their clients.

Q. Associated Parties

Associated parties are third party contacts within the present invention that are granted access to certain listing information on certain listings based on the property listing agent's action creating an association between the property listing and the contact.

Exemplary business rules for associated parties will be as follows. When selecting companies from which the associated parties will be selected, listing agents can only choose companies with whom the property listing agent's broker has already established an association. When selecting contacts from a chosen company, listing agents can only choose contacts with whom the property listing agent's broker has already established an association. The property listing agent can associate a selling agent, but cannot associate the buyer. The selling agent can associate the buyer. Deleting associated parties removes only the association between the contact and the property listing; it does not remove the contact from the present invention.

For security, only the property listing agent or the property listing agent's manager or broker can add, edit or delete associated parties, with the exception of the associated buyer. Only the selling agent can associate the buyer so as to protect the selling agent's client list.

R. Brokers Demand Form

The Brokers Demand Form contains critical information regarding the real estate transaction. This includes (but is not limited to) information regarding the buyer, seller, listing brokerage and agent, selling brokerage and agent, property being sold, title company, mortgage company, survey company, appraisal company, inspection company, form attachments, closing instructions, attorney instructions, special instructions and notes. The information contained on this form is included in the property listing file maintained at the property listing agency.

Exemplary business rules for the Brokers Demand Form are as follows. Brokers Demand forms must be attached to listings. Buyer name and street address, seller name and street address, selling brokerage and agent name, listing brokerage and agent name, property MLS number, property street address, and property purchase price must be entered to save a brokers demand form. Multiple brokers demand forms may be entered and saved for a given listing. If multiple brokers demand forms exist for a listing, the most recently added brokers demand form is considered to contain the most current information.

For security purposes, only the property listing agent, listing manager, listing broker, selling agent, selling manager, or selling broker can add a brokers demand form to a listing. Within the present invention is a security array that defines additional security for this form. Multiple user roles are defined based on the user's relationship to the property listing. For each role, access types including Hidden, View, and Edit are defined for each section of the form with Hidden being the most restrictive and Edit being the least restrictive. If a user falls into multiple roles, the user will be given the least restrictive access for each form section for all the roles into which the user falls.

S. Documents

Documents in the system are files that contain images or are actual digital representations of various documents that become part of the real estate transaction. Exemplary file formats include graphical formats such as JPG, GIF, TIFF, PNG, and BMP. Graphical documents may be the result of scanning document images into a computer system. Other exemplary formats include XLS (Microsoft Excel), DOC (Microsoft Word), TXT (generic text), or PDF (Adobe Acrobat), which are commonly used and recognized document formats that can contain an actual editable document rather than simply an image of a document.

The size and expected number of document files must be considered in determining storage requirements for the server and bandwidth usage in sending data from the web tier to the client tier. In the preferred embodiment no limit is set on the size of the document files.

The processes for entering and managing documents into the present invention are described in detail in a later section of this document.

Exemplary business rules for documents are as follows. Documents must be attached to listings. Documents can be loaded to the system using one of several different methods including direct upload, email, or fax. Some of these methods do not require logging into the present invention, nor do they require any system credentials in order to load documents. Once loaded into the system, documents are initially visible only to the property listing agent. The property listing agent reviews each document that is attached to a listing, assigns a name to each document, and determines the user roles to whom the documents will be visible. Documents may be marked as secured documents. If secured, documents can be viewed only through some form of encryption/decryption. In the preferred embodiment, Microsoft's Secure Socket Layer (SSL) is used for the encryption/decryption process. Documents can be emailed to others as long as the user has access to the document, the user supplies the destination email address, and the document has not been secured.

For security, only the property listing agent can change the access permissions for documents attached to the property listing. The property listing agent assigns view rights based on user roles. The property listing agent's manager or broker can change permissions only by masquerading as the property listing agent. For a given document, only users who fulfill roles to which view rights have been granted can view that document.

T. Schedule

The present invention contains a simple schedule process. Items added to a user's schedule are displayed on the user's home page. The user can add, edit, view or delete items on the schedule. Schedule items can be manually added. Some schedule items are automatically added based on other events within the present invention such as scheduling an open house.

Exemplary business rules for schedules will be as follows. Scheduled items must be related to a listing. An event name and date are required to save a schedule item. Scheduling an open house automatically adds a schedule item to the schedule of the property listing agent. Scheduled items with future dates are displayed on the user's home page. Scheduled items with past dates are not displayed but may still exist in the schedule system. Only brokers, managers, agents, and buying or selling clients can have schedule items.

For security, users can Add, Edit, View and Delete only items on their own schedule.

U. Deal Calendar

Deal calendars serve as an aid to brokers, managers, and agents to insure that all the various tasks required to complete a real estate transaction are completed in an expeditious manner. Deal calendars are developed in multiple stages. First, system administrators create master templates. These templates are available to all brokers for inclusion into broker-specific lists of templates. A broker may make brokerage-specific customizations for any templates included in the broker-specific list to create a Broker Template. A specific template can then be applied to a listing at the time the status of the property listing is changed to Pending.

The business rules for Deal Calendar Master Templates will be as follows. To save a master template the following must be entered: template name, associated financing terms, and represented. Examples of associated financing terms would include (but not be limited to) Assumption, Conventional, FHA, or VA. Examples of represented would include Seller or Buyer. The combination of template name, associated financing terms, and represented constitute a header record for the master template.

One or more detail records must be saved and associated to the header record for the template to be of use. To save a detail record the following must be entered: detail description, due date parameters, role of the party responsible for completing the task, process order within the template. Due date parameters consist of the following: a date field from the property listing or another detail record associated to the same master template or an indication that the task will simply be marked completed and is not based on another task or date, and a number representing the number of calendar days to be added to the value of the date field or the later of the due date or completion date of the other detail record. Examples of the role of the party responsible for completing the task would include (but not be limited to) Agent, Manager, or Broker.

Master templates can be flagged as Incomplete or Completed. Completed templates are visible and available to brokers for copying to their Broker Template list. Incomplete templates are not visible or available to brokers.

[For security, only System Administrators can add, edit or delete master templates. A system administrator retains this access regardless of any other role assigned to this user within the present invention.

The business rules for Deal Calendar Broker Templates will be as follows. To save a broker template, a broker must select one of the completed master templates to be copied to the broker's template list. The action of copying a master template to the broker's template list will copy the header record and all detail records for the template from the master template database to the broker's template database. After the template is copied to the broker's template database, the broker may edit the template as desired to make the template fit the broker's specific business model.

For security, only a broker (or the broker's staff) can copy master templates to the broker's template database. Only a broker (or the broker's staff) can edit templates within the broker's template database, or delete templates from the broker's template database. A broker (or the broker's staff) can see only the templates applied to that broker's brokerage. At no time can someone from one brokerage see the templates that belong to another brokerage.

The Deal Calendar includes specific tasks. The business rules for Deal Calendar Tasks will be as follows. Changing the status of a listing to Pending allows Deal Data to be entered and modified. Included in the Deal Data are fields for indicating who is being represented by the brokerage (buyer, seller, or both) and for the anticipated financial terms of the real estate transaction. Example of the anticipated financial terms would include (but not be limited to) Assumption, Conventional, FHA, or VA. The anticipated financial terms and representation are matched to associated financing terms and representation for templates in the broker's template database. If the deal data representation is set to Both, then both Buyer and Seller templates are matched. The user entering the deal data may (but is not required to) select a template from the list of matched templates.

Selecting a template will initiate the creation of one or two deal calendar task lists for the property listing based on the template. If the brokerage represents the seller, then a task list for the property listing agent will be created. If the brokerage represents the buyer, a task list for the selling agent will be created. If the brokerage represents both the buyer and the seller, one task list for the property listing agent and one task list for the selling agent will be created, assuming templates were initially created for both the buying and selling process. The property listing agent and the selling agent can be the same user.

After the task lists have been created, the present invention will execute a process in an attempt to establish a due date for each task. This process is executed for each task in the task list, in order based on the process order established in the template.

If the task due date is not based on either a listing due date or another task due date, then the due date is left empty.

If the task due date is based on a listing date, if the property listing date is filled in then the task due date is the property listing date plus the number of days specified for this task in the template. Otherwise the due date is left empty.

If the task due date is based on the date from another task, and if the date on the other task is filled in, then the task due date is the other task date plus the number of days specified for this task in the template. Otherwise the due date is left empty. The date used from the other task will be the effective date of that task if that task is completed and the effective date is filled in. Otherwise the date used from the other task will be the due date of the other task.

Tasks can be marked as completed by the responsible agent, the agent's manager, or the agent's broker. Upon marking a task as completed, the User ID of the person marking the task complete is stored with the task, and the effective date and actual completion date are set to the current date. In the preferred embodiment of the present invention, it is envisioned that the effective date for the task may be modified subject to certain rules that may be established, while the actual completion date would reflect that actual time at which the task was marked completed. One such example for the use of the effective date would be that a task was actually completed several days prior to the time at which the task is marked as completed in the present invention. It may be desirable to change the effective date of the task to reflect the actual time at which the task was accomplished.

Whenever any task in a task list is marked as completed, the due dates for all non-completed tasks in the task list are recalculated using the algorithm described above. Tasks marked as completed can in turn have the completion flag removed.

If desired, an agent can go back to the Deal Data and apply a different deal calendar template. If this takes place, the following process is applied. All non-completed tasks are removed. The new template is used to create a new task list. If any new task has the same description as a completed task, the effective date and completion date and user information from the completed task is copied to the new task, and the old completed task is deleted. Due dates for the new task list are calculated. It is possible that completed tasks from the old task list that did not match any new tasks will remain.

Additional tasks not in the template and specific to the property listing may be created by the agent and/or broker. These ad hoc tasks may depend on template-based tasks, but other template-based tasks cannot depend on ad hoc tasks. One or more notes can be added to any task at any time.

When task lists are retrieved from the database, tasks are flagged to indicate various statuses as determined by the due date in relation to the current date. These statuses may include (but are not limited to) Complete, Past Due, Due Today, Incomplete (with unknown due date), and Future. These statuses may be used to modify the visual interface of the present invention so as to easily classify tasks based only on the visual display. In one such embodiment of the present invention, the background color of a displayed task may be modified based on the status of the task. In such a case, a legend should be included to allow users to easily comprehend the meaning of the visual modification.

The task list should be retrievable in multiple orders and with various filters. These queries should include (but not be limited to) retrieving all tasks for a given day for all agents under a given broker, retrieve all tasks for a given day for a given agent under a given broker, retrieve all tasks of a given status for a given agent under a given broker, retrieve all tasks for a given listing for a given broker.

For security, agents can only see tasks for which they are responsible, and only on listing for which they are the property listing or selling agent. Brokers and managers can see all tasks for all agents within their jurisdiction. Agents can mark their own tasks as completed. Brokers and managers can mark tasks as completed for any agent under their jurisdiction. Any user with the authority to mark a task as complete is also granted authority to add notes to the task.

V. Selling Agent's Listings

In some cases, brokerages that make use of the present invention will sell properties for which they are not the property listing brokerage, and where the property listing brokerage does not make use of the present invention. In such instances, the selling brokerage wishes to make use of the capabilities of the present invention for the advantage of the selling brokerage. For this reason, a selling agent can enter listings. These listings are controlled within the present invention by the selling agent, however this control has no bearing on the legal status or ownership of the property listing. Selling Agent's listing are controlled by the office and can be edited by only the property listing agent (or the agent's assistant), the agent's broker, the agent's manager, or the broker's or manager's staff. These listings will not be loaded to the MLS system because this is not a new listing to the real estate environment, only to the present invention. Listings will be linked to the present invention home page for every user who is associated to the property listing. For each listing an unlimited number of pictures and documents can be associated.

It is assumed that, given the circumstances for using this option, that the property listing already exists in an MLS system, that the agent controlling this listing within the present invention is not the legal owner of the property listing, that the property listing does not exist elsewhere in the present invention (the property listing agent does not make use of the present invention), and that the reason that the selling agent is entering the property listing is because a deal has been started.

The business rules for selling agent listings will be as follows. To save a listing the following must be entered: buying client, selling agent, listing expiration date, listing active date, property ID, street name, city, state zip code, country, county, selling price, school district, and MLS style. It must be indicated that this listing is controlled by the selling agent rather than the property listing agent. The property listing status will default to Pending. MLS uploads will not be allowed. Only the subset of associated parties that relate to the selling agent can be associated with the property listing. Each listing is assigned a unique identification number within each embodiment of the present invention. This identifying number becomes known as the Document Routing Number for Digital Document Management.

Showing information, open house information, and advertisement information cannot be added to these listings. These listings cannot be sent to other prospective buyers.

Listing edits, status changes (with the exception of Active status), and archival abilities match those of standard listings.

For security, only the selling agent (or the agent's manager or broker or staff masquerading as the selling agent) can add new selling agent listings. Only the selling agent or the selling agent's manager or broker or staff can edit the property listing. Brokers and managers can delete listings or archive listings. Certain associated third parties can view the property listing. The buying client can view the property listing. Clients to whom the property has been advised by their agent can view the property listing.

W. Archiving

Archiving is the process where by listings or users are “set aside” so as not to be displayed during normal day-to-day activities within the present invention. This allows users to concentrate on current listings and clients.

Exemplary business rules for archiving will be as follows. Only listings and certain users can be archived. Listings can be archived at any time. Clients, client groups, and third party contacts are the only users who can be archived. Information for archived listings and users cannot be modified. Archived listings and users can be unarchived which returns the property listing or user to the exact state at which the property listing or user was prior to being archived. Listings and users that have been unarchived can be archived again.

For security, only users who have access to edit a listing can archive or unarchived the property listing. Only users who have access to edit a user can archive or unarchived the user. Users cannot archive or unarchived themselves.

VII. Email

Email is used throughout the present invention as a significant form of communication. Many people are involved in a real estate transaction and are often dependant on each other. When one person completes a step in the process, others need to be notified in order for them to proceed with their part. These notifications do not need to be direct verbal communication. In addition, some people involved in the process may be difficult to contact, as they may not spend significant time at one contact location. Email notification, therefore, provides an effective way to send a message and to allow the recipient of the message to collect the message at the recipient's convenience.

There are four primary uses of email in the present invention.
A. An email center exists for use by brokers, managers, agents, staff and assistants. The email center is primarily for communication within the brokerage and with clients. A user must select recipients from other users within the brokerage that have a relationship to the user, where the other users also have a primary email address designated within the present invention. The relationships are defined as follows. The broker is related to all managers, all agents, all clients, all staff and all assistants. Managers are related to the broker, other managers, clients and staff and assistants belonging to the manager, the manager's agents, and clients and assistants belonging to the manager's agents. Agents are related to the agent's broker, the agent's manager, and the agent's assistants and clients. Staff and assistants assume the same relationships as the user to whom they belong. Users choose the recipients, enter a subject, enter the message, and send the email.
B. Brokers, managers and agents who are reviewing a listing can send an email to anyone with an email address. The email sent will include a link to a visual interface that will display public information regarding the property listing. Users enter the recipient's email address, enter a subject, enter a message that will be added to the link, and send the email.
C. Documents that have been loaded to the present invention, are being viewed by a user with the proper access rights, and are not secured can be emailed to anyone with an email address. The documents are sent as email attachments. Users enter the recipient's email address, enter a subject, enter a message, and send the email.
D. Automated email messages have been established within the present invention to provide communication as various events occur. This aids the flow of the real estate transaction by using functions by one user to automatically notify another user that an event has happened.
E. Automatic advertising emails may be generated. Advertisements may include information from an associated property listing including the real estate company logo, property pictures, and marketing language that are all formatted in accord with typical media requirements, such as for newspapers and homes magazines.

The broker may control the automated email messaging system for all managers and agents within the brokerage, or the broker may optionally push that control to the individual managers and agents.

When a new brokerage is created within the present invention, all automatic emails are turned on by default. If the broker desires, the settings for each of the automatic email events in the present invention can be modified. The broker can choose to leave the event turned on, turn the event off, or allow each individual agent to select whether the event is on or off. Each event can be controlled individually.

If the event setting has been made to allow agents to make the selection, the agents (including the manger and broker) can do so from within their own user settings. Any agent selectable auto email settings are on by default. The agent can modify agent selectable auto email settings at any time.

For example, an agent is notified when the agent's client has logged into the present invention for the first time and accepted the user agreement.

For another example, all agents within a brokerage are notified when a new listing owned by the brokerage has been entered into the present invention.

For still another example, the property listing agent and the showing agent will both be notified when a showing has been scheduled. If the showing is confirmed, the notice sent to the showing agent will include a copy of the Seller's Disclosure and the Lead-Based Paint disclosure if such documents have been loaded into the present invention for the property listing.

For another example, the property listing agent and the showing agent will be notified if a previously scheduled showing has been confirmed. The notice sent to the showing agent will include a copy of the Seller's Disclosure and the Lead-Based Paint disclosure if such documents have been loaded into the present invention for the property listing.

In still another example, the property listing agent and the showing agent will be notified if a previously scheduled showing has been cancelled.

In yet still another example, if a showing is more than 48 hours past and no feedback has yet been entered, the showing agent will receive a notice reminding the agent that feedback is requested. The notice also includes a link to a visual interface where feedback may be entered.

For another example, the property listing agent will be notified when a showing agent has entered feedback on a showing.

For still another example, when the property listing agent approves access rights for documents attached to a listing, all users granted access rights are notified that a new document has been entered and is available for the user's review.

In another example, clients receive notice when the client's agent has advised a new listing to the client.

In order to send email, a preferred embodiment will utilize Microsoft's Collaboration Data Objects for Windows NT Server (CDONTS) as installed on the web server 48. Preferably CDONTS is accessed from ASP scripts on the web server 48. CDONTS interfaces with the SMTP (Simple Mail Transfer Protocol) server component of Microsoft Internet Information Server (IIS). The SMTP server component sends the email.

VIII. Digital Document Management

Digital Document Management (DDM) is a primary feature of the present invention and method of invention. Real estate transactions require multiple documents to be collected by the property listing agent for the property listing. These documents may be sent to the property listing agent using a variety of methods such as mail, email, fax, or even as a file on a computer disk. In turn, many of these documents must be made available to others involved in the real estate transaction. Finally, these documents must be maintained in a file controlled by the property listing brokerage.

DDM encompasses the methods used for entering documents into the present invention, providing access to those documents, and sending them where needed. In the preferred embodiment, these methods use processes that are ubiquitous to the office environment of a real estate company.

DDM also takes into consideration the security required for documents. Certain documents used in the real estate transaction include sensitive information that could include (but is not limited to) social security numbers, bank account numbers, and other private, identifying information. These documents should not be made generally available, but will be accessible only to those who need the information in order to complete the real estate transaction.

In the preferred embodiment, at least three methods are used for loading documents into the present invention. Documents can be loaded via fax, via email, or by a direct load into the present invention.

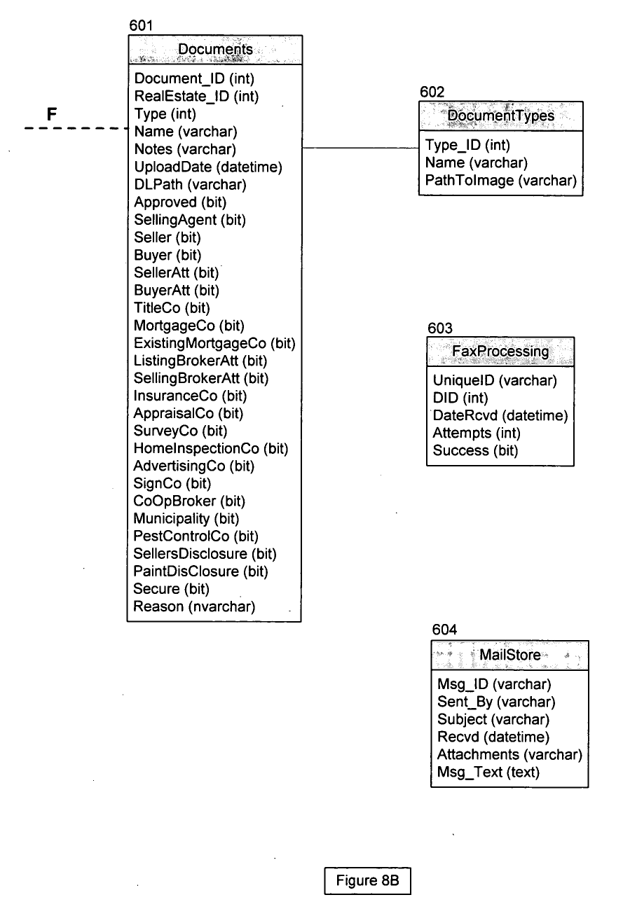

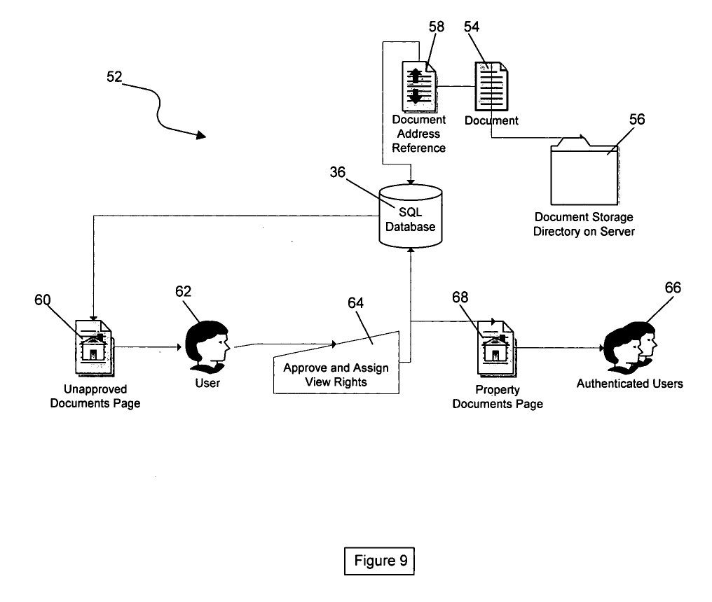

Referring again with specific reference to the drawing figures, FIG. 9 taken in conjunction with FIG. 2, illustrates an exemplary flow diagram for a DDM system 82, wherein digital document files can be loaded directly into the system of the present invention from a user's computer. This requires that the user has proper login credentials and has logged into the present invention. The user creates any type of digital document file using any means they wish. The user stores the document file in a network location accessible to their computer used for accessing the system of the present invention. The user logs into the system of the present invention and navigates to the visual interface where a document 54 may be loaded. The user enters the location and name of the document file, either by directly entering the name or by browsing the network and selecting the proper file. The electronic file of the document 54 is sent via the distributed network to a server 56, which may be the web server 48, and is stored in the memory thereof. A document address 58 that refers to the file or digital document representation is entered into one or more of the system database 36 and related to a respective property listing. In other words, a storage location in the server 56 is selected that is dependent upon the property listing to which the file is being associated. A random file name is generated and is verified to insure that it doesn't already exist. The document file is stored in the selected storage location on the server 56 with the randomly generated file name. The fully qualified storage location and generated file name are then entered into one of the databases 36 in association with the appropriate property listing. The newly entered document 54 is visible through a visual interface 60 to a listing agent 62. As indicated by event 64, the property listing agent 62 approves the document 54 and grants view rights to authenticated users 66 who fulfill various roles on the property listing. Those users 66 can access and view the digital representation of the document 54 via a property documents page 68.

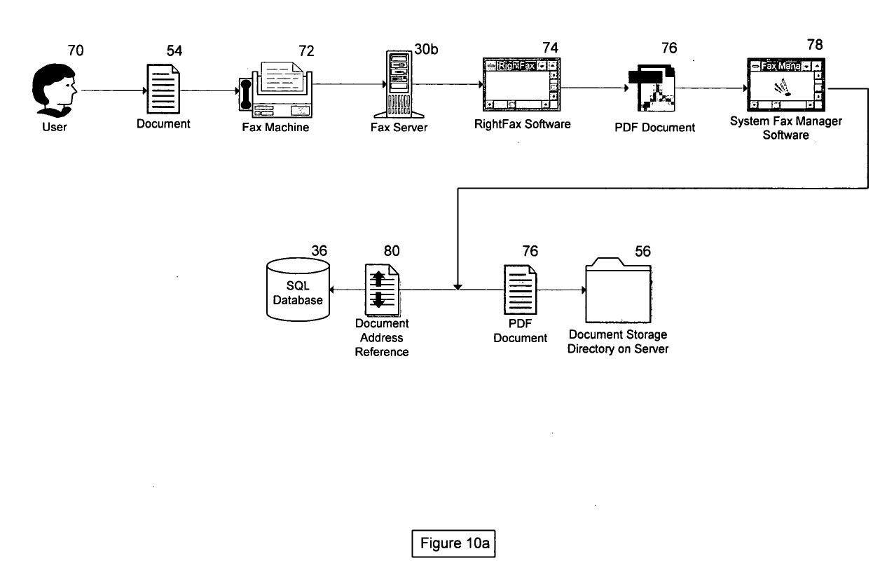

Referring to FIG. 10a, a graphical flow diagram depicts an exemplary process for accepting documents into the present invention via fax. Any person 70, whether a registered user of the system or not, who needs to attach a document 54 to a property listing uses a fax machine 72, or any equivalent means such as fax software, to dial a central fax number that connects the fax machine 72 to the fax server 30b of the system of the present invention. Preferably, there need only be one fax number to dial into the system. Alternatively, there could be more than one fax number. The point, however, is that the system of the present invention does not require providing hundreds or thousands or more fax numbers, such as an amount that corresponds to the number of property listings or number of clients, etc. Thus, it is not necessary to incur the expense of providing multitudes of fax numbers for the system of the present invention to work.

In the preferred embodiment, the fax server 30b is running RightFax Enterprise Fax Manager 74 on the fax server 30b that is capable of producing a digital document 76 from the fax document 54. One or more fax cards capable of receiving faxes must be installed in the fax server 30b, and the fax cards must be connected to a telephone line or the like that capable of receiving faxes. The Rightfax Enterprise Fax Manager has the capability to create multiple fax “mailboxes”. These mailboxes can be assigned to various people or established for other reasons where fax documents should be channeled to one of multiple areas and/or where privacy may be a concern. By default, one administrator mailbox is always established by Rightfax.

After dialing the central fax number, but prior to sending the fax, the person 70 is voice prompted to enter a mailbox number (aka the Document Routing Number which was discussed previously above) by a procedure or fax manager software 78 that is loaded to one or more of the servers of the system of the present invention. This identifying DRN is the same number that uniquely identifies the property listing within the databases 36 of the system. The person 70 then enters the DRN number, such as by keypad entry that generates tones such as with a touch-tone dialing system. Then the person 70 sends the fax as consistent with current knowledge in the art of fax transmission.

With continuing reference to FIG. 10a, the RightFax Enterprise Fax Manager 25 software receives the fax and converts the fax into the digital document 76 in Adobe Acrobat (PDF) format and assigns a system generated name to the image. The fax manager software 78 that is loaded to the fax server 30b runs at predetermined time intervals, which are set to about (but not limited to) 15 seconds. The software 78 reads one or more of the databases 36 associated with the RightFax software 74 looking for new fax documents that may have been received. If new documents are found, the software 78 uses the information from the RightFax database to locate the PDF document 76 and identify the property listing to which the document 76 should be attached. If a match is found, the software 78 moves the fax PDF document 76 to the document storage location 56. At the same time, the software 78 enters a new item into one of the system databases 36 that contains a document address reference 80 and relates the address reference 80 to the property listing using the respective DRN. The new item may also include information about the fax document including (but not limited to) the PDF document name, the mailbox number, information transmitted from the sending fax machine, and the date and time of receipt. If a match cannot be found between the entered mailbox number and the established mailboxes or document storage locations on the fax server, the fax will go into an administrator's mailbox by default.

Referring to FIG. 10b, the process for accepting documents into the system of the present invention via fax is illustrated in another format. In step 700, a person desiring to send a document into the present invention via fax dials a phone number assigned to a telephone line to which the fax server is connected. The person receives a message instructing them to enter the Document Routing Number. The person enters the Document Routing Number using a method that generates tones used in a touch-tone telephone system. For one example, the person may use the dial pad built into their fax machine. The person then receives a message instructing them to start the sending process. The person starts the fax sending process using methods appropriate to the mechanism they are using with which to send the fax document.

With continuing reference to FIG. 10b, in step 701 the fax server receives the document. The Rightfax Enterprise Fax Manager understands the Document Routing Number that was entered in 700 to be a mailbox number. In step 702, Rightfax attempts to find a mailbox with such a number, but no such mailbox was ever established. Because no mailbox is found, Rightfax proceeds to step 703. The incoming fax image is converted to an Adobe Acrobat (PDF) format. A system-generated name is assigned to the fax image file. The fax image file is stored in the file storage of the fax server in an area designated as the storage area for the administrator mailbox. In addition, a record is stored in the Rightfax Enterprise Fax Manager database with the fax image's file name, the mailbox number, and other information.

Still referring to FIG. 10b, a system fax manager is continuously running at step 704 on the fax server at predetermined time intervals. Again, this interval is set to (but is not limited to) 15 seconds. At step 705, the system fax manager reviews the data contained in the Rightfax Enterprise Fax Manager database to determine if new fax documents have been received. If no new fax document records are discovered, the system fax manager stops until the end of the current interval and returns to step 704. If a new fax document record is discovered, the system fax manager retrieves the mailbox number, the file name, and the storage location of the fax document from the Rightfax Enterprise Fax Manager database. At step 706, the system fax manager makes a determination as to whether the mailbox number, which the system fax manager understands as the Document Routing Number, is greater than zero. If the mailbox (Document Routing) number is zero, the fax document cannot be moved to a valid listing, as no valid listings will have a Document Routing Number of 0 and the process proceeds to step 707. At step 707, the fax is discarded, and the record in the Rightfax Enterprise Fax Manager database is marked as processed.

With continuing reference to FIG. 10b, at step 708, if the mailbox (Document Routing) number is greater than zero, then the system fax manager validates the mailbox (Document Routing) number against one or more of the databases of the present invention. If no listing is found where the mailbox (Document Routing) number matches the property listing Document Routing Number, then the fax document cannot be moved to a valid listing. As shown in step 709, the fax is therefore discarded, and the record in the Rightfax Enterprise Fax Manager database is marked as processed.

Still referring to FIG. 10b, if a listing is found where the Document Routing Number of the property listing matches the mailbox (Document Routing) number of the fax document, the fax will be associated to the property listing using the process as described in step 710. The fax document PDF file will be moved from the file storage area on the fax server to the file storage location on the system server designated for fax documents for the property listing with this Document Routing Number. A Document Address Reference is added to the property listing in the system SQL database. The database entry in the Rightfax Enterprise Fax Manager database on the fax server is marked as processed and the process returns to step 704.

In the preferred embodiment, both the Rightfax Enterprise Fax Manager and the system fax manager reside on the fax server. The system fax manager accesses the system SQL database server and the fax file storage areas via a mapped drive on the fax server.

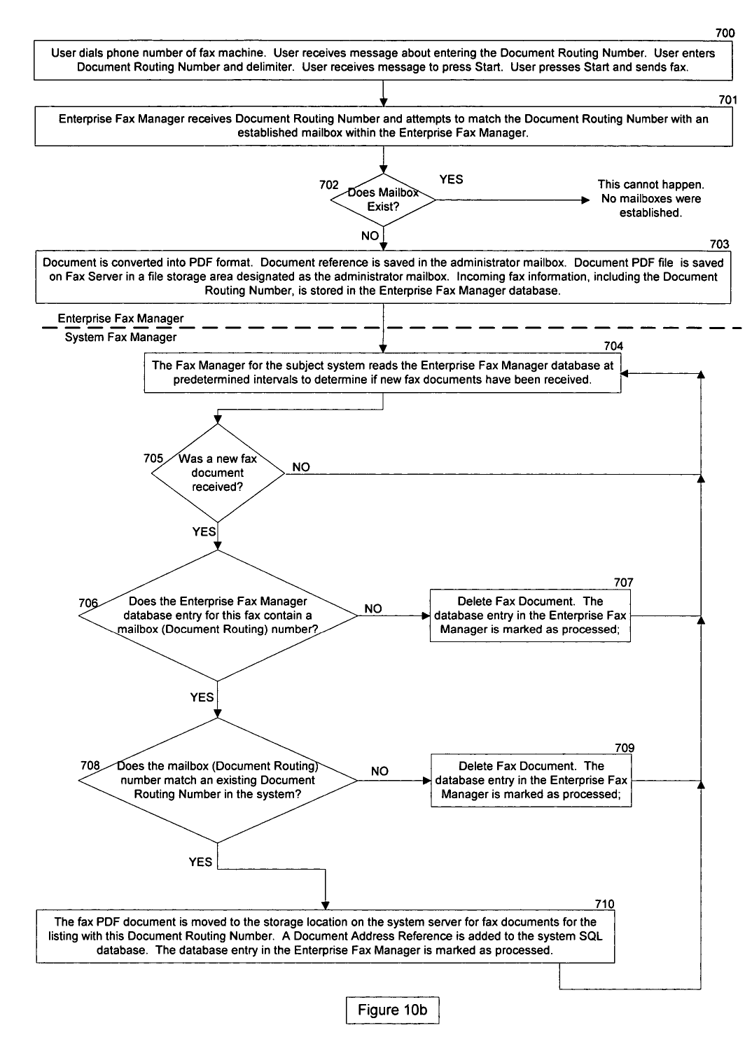

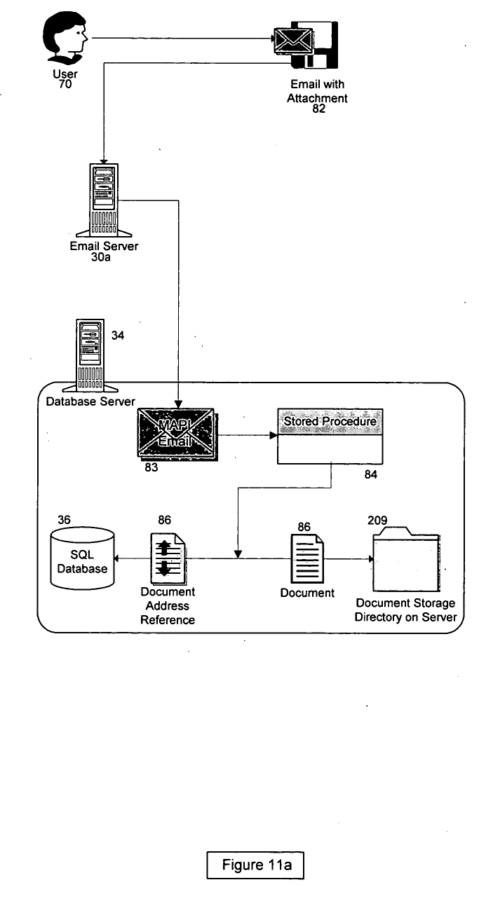

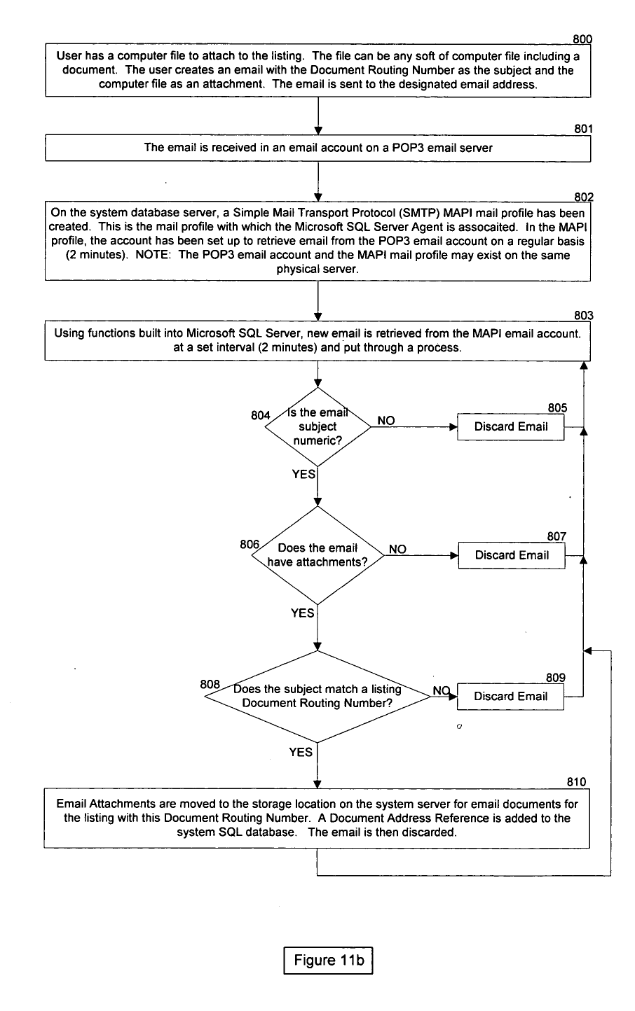

Referring now to FIG. 11a, an exemplary process for accepting documents into the present invention via email is illustrated. A person 70 needing to attach a digital document to a property listing creates an email 82 and attaches the digital document thereto. The subject line of the email 82 must contain the Document Routing Number (DRN) of the property listing to which the digital document will be attached. The subject line of the email 82 should not contain anything other than the DRN. The email 82 is directed to an email account established on the email server 30a that is also associated with the database server 34.

With continuing reference to FIG. 11a, a Messaging Application Programming Interface (MAPI) profile 83 is loaded on the database server 34 and communicates with the email server 30a. In turn, a procedure or email software 84 communicates with the MAPI profile 83 and runs at predetermined time intervals. In the preferred embodiment, this interval is set to (but is not limited to) 2 minutes. This software 84 examines the email inbox on the system for any new email messages. If new messages are found, the software 84 examines the email messages for a valid DRN in the email subject and any attachment files. If the DRN is valid and attachment files are found, the software 84 locates the attachment files 86 and moves the attachment files 86 to the document storage location 56. At the same time, the software 84 enters a new item into one or more of the databases 36 of the present invention for each attachment file 86 containing a document address reference 86 and relates the address 86 to the respective property listing using the DRN.

Referring to FIG. 11b, the process for accepting documents into the system of the present invention via email is illustrated in another format. As shown in step 800, a person desires to attach a computer file to a property listing in the system of the present invention. The computer file can be in any format including (but not limited to) text files, Microsoft Word documents, CAD drawings, Microsoft Excel spreadsheets, or other standardized forms and/or documents. The person 200 first creates an email, the subject of which is to contain only the Document Routing Number of the property listing to which the computer file is to be attached. The computer file is added to the email as an attachment using the normal method of adding attachments within the email software being utilized. The contents of the body of the email are irrelevant, and the body can be left empty. The email is addressed to the email address designated to receive emails for that embodiment of the present invention. The email is sent to the email address using regular methods for transmitting electronic mail messages over a network.

With continuing reference to FIG. 11b, and as depicted in step 801, in the preferred embodiment the email with attachment is received in an email server running a POP3 email system. A POP3 email system allows access to specific email accounts from remote computers via a network as long as proper credentials are provided.

Still with continuing reference to FIG. 11b, and as depicted by step 802, the present invention database server has installed on it Microsoft Office 2000, which installs a Simple Mail Transport Protocol (SMTP) service on the server, and allows for the creation of the Messaging Application Programming Interface (MAPI) profile on the database server. The use of this MAPI profile is two-fold. First, the profile is used to retrieve email over a network from the POP3 email account on the email server at a specified time interval. In the preferred embodiment, this interval is set to (but not limited to) two (2) minutes. Second, the SQL Agent service that is running on the database server as part of the Microsoft SQL Server database service is set to use the MAPI profile for Mail Services. This provides a channel for processes within the database that need email access.

As shown in step 803, a stored procedure within one or more of the databases is executed at a set time interval. In the preferred embodiment, this interval is set to (but not limited to) two (2) minutes. This procedure is designed and implemented as part of the present invention and uses standard external procedures installed with the Microsoft SQL Server database, which in turn use the SQL Server Agent service to retrieve email stored in the email account associated with the MAPI profile. The standard external procedures return to the stored procedure information about each email including (but not limited to) the date and time the email was received, the subject of the email, and the storage address and file name within the server's file storage area of each email attachment.

The stored procedure makes several determinations based on the subject of the email and the quantity of email attachments. It is intended that the subject of the email should contain the Document Routing Number of the property listing to which the email attachment computer files should be associated.

As shown in step 804, a determination is made as to whether the email subject represents a numeric value. If the email subject does not represent a numeric value, the email is discarded at step 805, otherwise the determinations continue. At step 806, a determination is made as to whether attachments were included with this email. If no attachments were included with this email, the email is discarded at step 807, otherwise the determinations continue. At step 808, a determination is made as to whether the numeric value represented in the email subject matches any known Document Routing Number within the embodiment of the present invention. If the numeric value represented in the email subject does not match any known Document Routing Number within the embodiment of the present invention, the email is discarded at step 809, otherwise the process continues.

At step 810, if the email passes all the determinations, then the email is recognized to indeed contain attachments, and the email subject represents a numeric value that matches a valid Document Routing Number within the embodiment of the present invention. That Document Routing Number, in turn, uniquely identifies a listing within the present invention. Using the file storage information of the email attachment as returned to the stored procedure by the standard external procedures, the stored procedure moves the attachment computer files to the file storage location on the system server designated for email attachment computer files for the property listing with this Document Routing Number. The procedure assigns new, system-generated names to these files that are guaranteed to be unique within the storage area. A Document Address Reference is added to the property listing in the system SQL database for each email attachment computer file. After this process is completed, the email is discarded.

Documents loaded into the present invention must be made available for those with proper access. As described earlier, the property listing agent approves the document and selects the user roles allowed to view the documents.

A user that has an association to a listing can view a document if the document is approved, and if the user's role for that listing matches at least one of the roles for the document to which view rights have been granted. If the document has been marked as secure, the document will be viewed using SSL. If the document has not been marked as secure, it can be emailed to other people as described previously. The email recipients do not require login credentials to the present invention.

If a user is viewing a document, then the digital image of the document has been transmitted from the web server 48 to the client computer and resides in the client computer's memory. In one embodiment the user then has the ability to print the document at the user's location and/or to save the document in a network location accessible to the user's computer.

In the present invention, a unique Document Routing Number is automatically assigned to each listing at the time the property listing is entered and saved to the database. The Document Routing Number is used to uniquely identify a particular listing within an embodiment of the present invention. The Document Routing Number is attached to incoming faxes and emails and is used to attach the incoming documents to the proper listing.

IX. Auditing

The audit process provides a means whereby certain activities taking place within the present invention can be tracked. The number of items to be tracked must be balanced with the storage limitations of the server and with the needs of those systems, processes, and people who need the audit data.

Each audit transaction will include information regarding the date and time, the user logged in, the user being masqueraded (if applicable), the associated listing (if applicable), links to other database information such as the associated document or appointment or picture (if applicable), a description of the action, and the IP address of the user for identification purposes.

For listings, audit transactions are saved every time data is added to, changed, or deleted from a listing. This includes (but is not limited to) new listing entry; changes to general info; changes to extended info; changes to features; changes to rooms; changes to status information; the addition of advertisements, pictures, open houses, showings, and documents; the maintenance or deletion of advertisements, pictures, open houses, showings, and documents; changing the primary picture; approving documents; changes to document view rights; deleting a listing; archiving a listing, and unarchiving a listing. Audit transactions are created every time a listing-related document is viewed. Audit transactions are not created for normal viewing of most listing information.

For users, audit transactions saved in addition to those for listings include (but are not limited to) user login, user logout, masquerade start, and masquerade end.

Audit transactions are created when automatic email notifications are sent and include the email address of the intended recipient.

A report showing all audit activity associated with a listing is available to the property listing broker and listing manager. This report is described in detail in the Reports section of this document.

A report showing all audit activity associated with a user is available to the broker and manager that own the user. This report is described in detail in the Reports section of this document.

X. Reports and Forms

In a preferred embodiment, a multitude of reports are generated. It is envisioned that data could be exported in a multitude of formats to allow users of the invention to generate their own reports.

In one embodiment, the standard list of reports vary from simple (i.e., report usually consisting of a simple listing) to complex (i.e., reports with multiple sorts, calculated fields, and the ability to select one or more ranges). For example, a Property Detail Report is a selection of information related to a listing. The Property Detail Report can be run for any property listing to which the user has access. The Property Detail Report adheres to several rules as follows: (i) only showings from 30 days prior to the run date are counted; (ii) only open houses scheduled in the 30 days prior to or currently scheduled within 30 days after the run date are counted; (iii) only ads published in the 30 days prior to or scheduled to be published within 30 days after the run date are counted; (iv) only showing feedback from 30 days prior to the run date is displayed; (v) only showings scheduled within 30 days after the run date are displayed.

For another example, the Appointment Report is a list of all showings for a given listing. The Appointment Report can be run for any property listing to which the user has access. The Appointment Report displays shows appointments in reverse date order from the most recent to the oldest.

For yet another example, an Advertisement Report is a list of advertisements placed for a given listing as entered into the present invention. The Advertisement Report can be run for any property listing to which the user has access. The Advertisement Report can be sorted by any one of Date Placed, Date Published, Expire Date, Description, or Placed Where.

For still another example, a Sales Data Report is a list of all advertisements, open houses, and showings for a given listing. The Sales Data Report can be run for any property listing to which the user has access. The Property Detail Report adheres to several rules as follows: (i) advertisements, open houses, and showings are separate sections on the report; (ii) for each section, items are displayed in reverse date order (most recent to oldest); (iii) at the top of each section is a count of the number of items within the section.

For yet still another example, a Picture Report is a list and display of all picture files, with captions, for a given listing. The Picture Report can be run for any property listing to which the user has access.

In yet still another example, an Audit Report is a list of activity against a given listing by all users. The Audit Report can be run by a broker or manager for any property listing that originated in their brokerage or office, respectively. The Audit Report can be sorted in ascending or descending order by any one of Date, Logged In, or ID. The Audit Report provides links from certain transaction details to other areas of the present invention where applicable. For example, where documents, advertisements, or showings are referenced, links to those items are provided as part of the report. Where pictures are referenced, thumbnail images of the pictures are included on the report.

In yet still another example, a Broker Summary Report provides a summary of recent activity to a broker. The Broker Summary Report can be run only by a broker, and can only be run for the brokerage owned by the broker requesting the report. The Broker Summary Report displays several summary values (counts) for various data. The Broker Summary Report adheres to several rules as follows: (i) active properties are those listings within the brokerage where the property listing status is Active; (ii) pending properties are those listings within the brokerage where the property listing status is Pending; (iii) closing properties are those listings within the brokerage with a status of Active or Pending, and that have an Estimated Closing Date; (iv) past closings are those listings where the status is Closed and that have a Closed Date.

For another example, a Broker Hot List Report provides a list of property listings within the brokerage that have not sold, or where the property listing status is Expired and the property listing Expiration Date falls within a specified date range. The Broker Hot List Report can be sorted by one of Status, Property ID, MLS Code, Address, School District, Area Number, Price, Lot Size, Square Footage, or Listing Agent. The Broker Hot List Report adheres to several rules as follows: (i) vacant land listings will not be included in this report; (ii) all listings with a status of Active, Pending, Off-Market, or 72-Hour Contingency will be included; (iii) listings with a status of Expired will be included only if the Expiration Date falls within the specified date range.

For another example, a Broker Vacant Land Hot List Report provides a list of property listings within the brokerage that have not sold, or where the property listing status is Expired and the property listing Expiration Date falls within a specified range, and the property is vacant land. The Broker Vacant Land Hot List Report can be sorted by one of Status, Property ID, MLS Code, Address, School District, Area Number, Price, Lot Size, Square Footage, or Listing Agent. The Broker Vacant Land Hot List Report adheres to several rules as follows: (i) vacant land listings are the only listings included in this report; (ii) all listings with a status of Active, Pending, Off-Market, or 72-Hour Contingency will be included; (iii) listings with a status of Expired will be included only if the Expiration Date falls within the specified date range.

In still another example, an Agent Summary provides a list of all listings in the present invention for which the user requesting the report is the property listing agent. The Agent Summary Report can be sorted by one of Property ID, Status, Active Date, Pending Date, Closing Date, Off-Market Date, Expiration Date, or Price.

In another example, an Expiring Listings Report provides a list of all listings in the present invention where the property listing Expiration Date falls within a specified date range, and where the property was available for purchase at the time of the expiration date or the current date, whichever is earlier. The Expiring Listings Report can be sorted by one of Status, Property ID, Expiration Date, Address, Price, or Listing Agent. The Expiring Listings Report adheres to several miles as follows: (i) listings with a status of Closed or Off-Market are not included; (ii) vacant land properties are not included; (iii) the properties displayed depend on the user requesting the report. Brokers see all listings within the brokerage that meet the criteria. Managers see all listings within the manager's office that meet the criteria. Agents see only the properties the agent has listed that meet the criteria.

In another example, an Expiring Vacant Land Listings Report provides a list of all listings in the present invention where the property listing Expiration Date falls within a specified date range, and where the property was available for purchase at the time of the expiration date or the current date, whichever is earlier. The Expiring Vacant Land Listings Report can be sorted by one of Status, Property ID, Expiration Date, Address, Price, or Listing Agent. The Expiring Vacant Land Listings Report adheres to several rules as follows: (i) listings with a status of Closed or Off-Market are not included; (ii) only vacant land properties are included; (iii) the properties displayed depend on the user requesting the report. Brokers see all listings within the brokerage that meet the criteria. Managers see all listings within the manager's office that meet the criteria. Agents see only the properties the agent has listed that meet the criteria.

In still another example, a Relo/Referral Summary Report is a list of all referrals for relocation for both buyer clients and seller clients for the user requesting the report. Referred buyer clients and referred seller clients are displayed as two distinct sections of the report. The Relo/Referral Summary Report can be sorted by one of Client, Relo Type, File #, Agent, Open, Date listed/Pending/Closed, Property Specialist, Relo Counsel, Property Address, Property Price. The Relo/Referral Summary Report adheres to several rules as follows: (i) buyers and sellers are maintained as two separate sections regardless of the sort order; (ii) archived users are not displayed.

In another example, a Closed Summary Report is a list of all listings in the present invention where the property listing Closed Date falls within a specified date range. The Closed Summary Report can be sorted by one of Property ID, Deal Number, MLS Number, Property Address, Agent Name, Sale Price, Closed Date, Closed Location, Title Company, or Mortgage Company. The Closed Summary Report adheres to several rules as follows: (i) the status of the property listing must be Closed; (ii) the property listing Closed Date must fall within the date range specified; (iii) the properties displayed depend on the user requesting the report. Brokers see all listings within the brokerage that meet the criteria. Managers see all listings within the manager's office that meet the criteria. Agents see only the properties the agent has listed that meet the criteria.

In still another example, a Closing Summary Report is a list of all listings in the present invention where the property listing Estimated Closed Date falls within a specified date range. The Closing Summary Report can be sorted by one of Property ID, Deal Number, MLS Number, Property Address, Agent Name, Listing Price, Estimated Closed Date, Closing Location, Title Company, or Mortgage Company. The Closing Summary Report adheres to several rules as follows: (i) the property listing Estimated Closed Date must fall within the date range specified; (iii) the properties displayed depend on the user requesting the report. Brokers see all listings within the brokerage that meet the criteria. Managers see all listings within the manager's office that meet the criteria. Agents see only the properties the agent has listed that meet the criteria.

For another example, an Advertising Detail Report is a list of all advertisements in the present invention where the advertisement Date Placed falls within a specific date range. The Advertisement Detail Report can be sorted by one of Property ID, MLS Code, Publication, Date Placed, Date Published, Placed By, Ad Description, and (listing) Status. The Advertising Detail Report adheres to several rules as follows: (i) the advertisement Date Placed must fall within the date range specified; (ii) the advertisements displayed depend on the user requesting the report. Brokers see advertisements that meet the criteria related to all listings within the brokerage. Managers see advertisements that meet the criteria related to all listings within the manager's office. Agents see only the advertisements that meet the criteria related to properties the agent has listed.

For still another example, an Advertisement Cost Summary Report is a list of all advertisements in the present invention where the advertisement Date Placed falls within a specific date range, sorted primarily by agent. Calculations are performed with the results displayed to show total advertisement costs by agent, and total advertisement costs. The Advertisement Cost Summary Report can be sorted within agent by one of Date Placed, Ad Code, Publication, or Ad Cost. The Advertisement Cost Summary Report adheres to several rules as follows: (i) the advertisement Date Placed must fall within the date range specified; (ii) the advertisements displayed depend on the user requesting the report. Brokers see advertisements that meet the criteria related to all listings within the brokerage. Managers see advertisements that meet the criteria related to all listings within the manager's office. Agents see only the advertisements that meet the criteria related to properties the agent has listed.

For still another example, an Advertisement Publisher Cost Summary Report is a list of all advertisements in the present invention where the advertisement Date Placed falls within a specific date range, sorted first by publication, then by agent. Calculations are performed with the results displayed to show total advertisement costs by agent within a publication, total advertisement costs within a publication, and a grand total for the report. The Advertisement Publisher Cost Summary Report adheres to several rules as follows: (i) the advertisement Date Placed must fall within the date range specified; (ii) advertisements are not displayed as line-item details; (iii) only subtotals for agents within a publication are displayed as line-item details; (iv) subtotals for a publication are not displayed if only one agent used the publication; (v) the advertisements displayed depend on the user requesting the report. Brokers see advertisements that meet the criteria related to all listings within the brokerage. Managers see advertisements that meet the criteria related to all listings within the manager's office. Agents see only the advertisements that meet the criteria related to properties the agent has listed.

In another example, a Grouped Advertisement Report is a list of all advertisements in the present invention where the advertisement Placed Date falls within a specific date range, displayed in a hierarchical order. At the highest level of the hierarchy is the broker. Within the broker, each manager and each agent reporting directly to the broker is displayed. Within each manager, each agent reporting to the manager is displayed. Within each agent, whether under a manager or the broker, each property listing is displayed for which that agent is the property listing agent. Within each property listing, all advertisements for that listing that meet the criteria are displayed. Listings are not displayed if no advertisements that meet the criteria exist for that listing. Agents are always displayed. Managers are always displayed. The broker is always displayed. Only the broker can request this report.

In still another example, a Deal Information Report is a list of selected information from deal data, including commissions, for listings where the Estimated Close Date or the Closed Date fall within a specified date range. The Deal Information Report can be sorted by one of Office Manager, Agent, or Date. The Deal Information Report adheres to several rules as follows: (i) the user requesting the report can choose whether to display only closing deals (Estimate Close Date in date range) or only closed deals (Closed Date in date range); (ii) only brokers and managers can request this report; (iii) when sorted by Date, only total commissions for the broker are calculated and displayed; (iv) when sorted by Office Manager, a subtotal of commissions for each manager and a total of commissions for the broker are calculated and displayed; (v) when sorted by agent, the agents are sorted within the hierarchy of their respective managers; (vi) when sorted by agent, a subtotal of commissions for each agent and manager, and a total of commissions for the broker are calculated and displayed; (vii) the deals displayed depend on the user requesting the report. Brokers see deals that met the criteria related to all managers, agents, and listings within the brokerage. Managers see deals that meet the criteria related to all agents and listings within the manager's office.

In still another example, an Audit Report of user activity is a list of activity by a given user that falls within a specified date range. The Audit Report can be sorted by one of Date or ID. The Audit Report adheres to several rules as follows: (i) only brokers or managers can request this report; (ii) the user requesting the report can request the report only for users that are owned by the requesting user; (iii) only activity that falls within the specified date range will be displayed; (iv) all activity that falls within the specified date range will be displayed, regardless of whether the activity is associated to a listing.

For still another example, a Contact Listing Associations report is a list of listings to which a specific third-party contact is associated. The Contact Listing Associations report adheres to several rules as follows: (i) only brokers can request this report; (ii) this report can be requested only for third party companies and contacts to which the requesting broker has established a relationship within the present invention.

In another example, a User Login ID And Password report is a list of login credentials for users owned by the user requesting the report. The User Login And Password Report adheres to several rules as follows: (i) only brokers and managers can request this report; (ii) the users displayed on the report depend on the user requesting the report. Brokers see all users owned by the broker. Managers see only users owned by the manager.

In still another example, an Advertiser Report displays selected listings in various formats as selected by the broker. The Advertiser Report adheres to several rules as follows: (i) only brokers can select advertiser reports; (ii) the broker's logo will be used as part of the report if provided, otherwise text information regarding the brokerage name and address will be used; (iii) layouts have been predefined within the present invention; (iv) property listings selected for inclusion must have a status of Active or Pending and must not be archived.

XI. Centralized Embodiment for Various Entities

In the preferred embodiment, a central entity will create the system environment in order to rent capacity to real estate companies. The real estate companies can lease the service provided by the system environment in proportion to usage. This removes the real estate companies from the burden of implementing and maintaining a system environment.

XII. Deployment, Operation and Backup

Initial installation of the software required to support the present invention and method of invention may be via CD ROM, network share, or downloading via modem. Updates of the software components may be accomplished using the same methods. It is envisioned that after installation ongoing management of the hardware and software components that make up the system will be required. Preferably, basic performance monitoring will utilize the built-in tools provided by Windows 2000, IIS, and SQL Server.

Accordingly, ASP and IIS performance can be monitored using the Performance Monitor included with Windows 2000. Such monitoring would be activated only on an “as needed” basis, as performance monitoring utilizes resources shared by the present invention. Performance monitoring can be logged for later review. Statistics gathered through monitoring could be reviewed by qualified personnel and used to tune the system. In one embodiment, the performance log contains a detailed record of users accessing the system, the pages accessed, and the time the users spent on each page.

In another embodiment, the databases 36 can be monitored using services provided through SQL Server. Statistics considered for monitoring include but are not limited to percentage of processor time, logins, logouts, transactions per second, and percent of logs used. A System Administrator can also set up alerts for notification when the log has reached a predetermined threshold. If performance is lacking, several options are available to enhance performance. For example, using the SQL Profiler software tool that is included with SQL Server, a log of activity against the database can be captured. This log can be fed through the Index Tuning Wizard, another software tool also included with SQL Server. The Index Tuning Wizard can make recommendations for changes to table indexes in the database to enhance performance.

The system and method also contemplate backing up or archiving of pertinent data. While it is possible that a multitude of schemes of what data to back up and how often will suffice, the guidelines which follow provide an exemplary scheme. Data affected by the operation of the system, and data that affects the operation of the system should be backed up. The SQL Server database that contains all of the operational data for the present invention, along with all related picture files and document files, should be backed up. In addition to backups of data, database log files can be backed up. Should restoration be required, the database log files can be used to restore the database to a given state through a specified transaction time while at the same time reducing the system load required to execute backup processes. System coding, including the ASP files and other executable procedures should also be backed up, though less frequently than the data.

The frequency required for backups should correlate to the frequency of data modifications and how recent the data must be in the event of a failure. For example, the ASP files and executable processes do not change frequently, so a weekly backup may be acceptable. If, in the event of a failure, it would be sufficient to restore the data to its state from the end of the previous day, a nightly backup would be sufficient. However, if the data changes frequently and it is important to stay more current, the log files could be backed up. Increasing the frequency of log file backups decreases the window of time in which data would be lost in the event of a failure. When determining backup frequency, the impacts on system performance and resources (including personnel, if necessary), and the links between database data and system-related files external to the database must be considered.

XIII. Exemplary User Interfaces

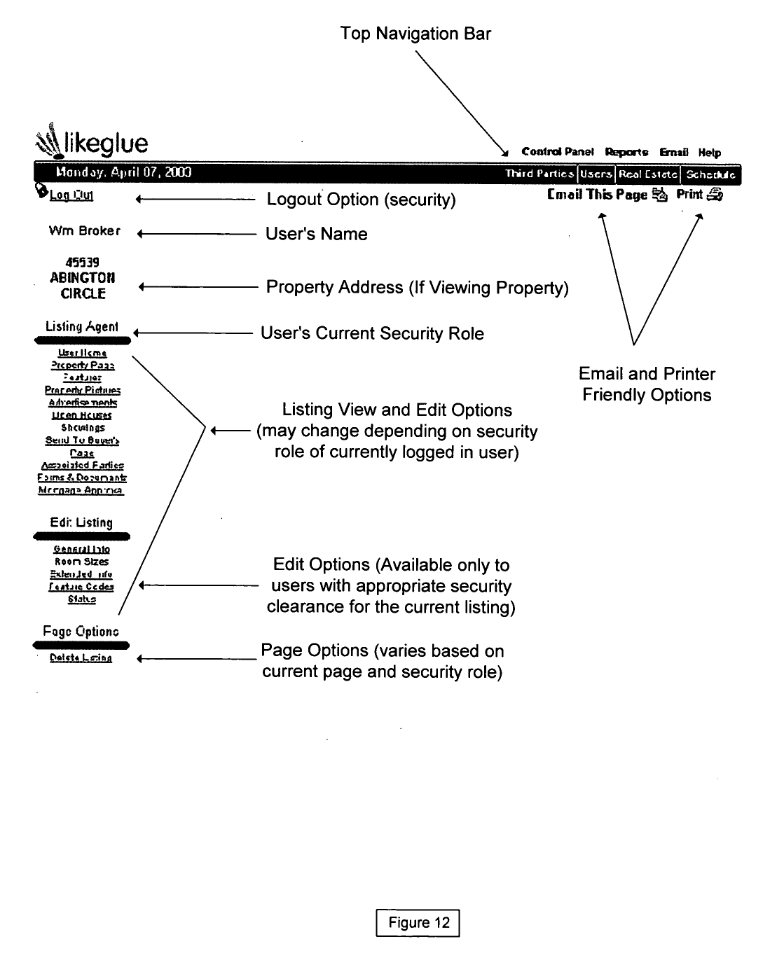

Referring to FIG. 12, the navigation from an exemplary World Wide Web page (“web page”) is illustrated. It should be recognized that “web page”, “screen”, “window” and “visual interface” will be used interchangeably in this specification. Web tier sends data to the client tier where it is used by the browser on the client machine to create the visual interface that is displayed to the user. Each web page has some form of visual interface navigation that is displayed along with the requested information. The Logout Option provides the user with the means of exiting the present invention. The User's Name, Property Address, and Current Security Role provide information regarding the user's current state in the present invention and who the present invention understands the user to be. The navigation provides the user with access to various Listing View and Edit Options. The options available will be dependent on the user and the user's relationship to the selected listing. Page Options are displayed only on selected web pages and for users with the proper security roles. The options available in the Top Navigation Bar are dependant on the user and the user's role within the present invention.

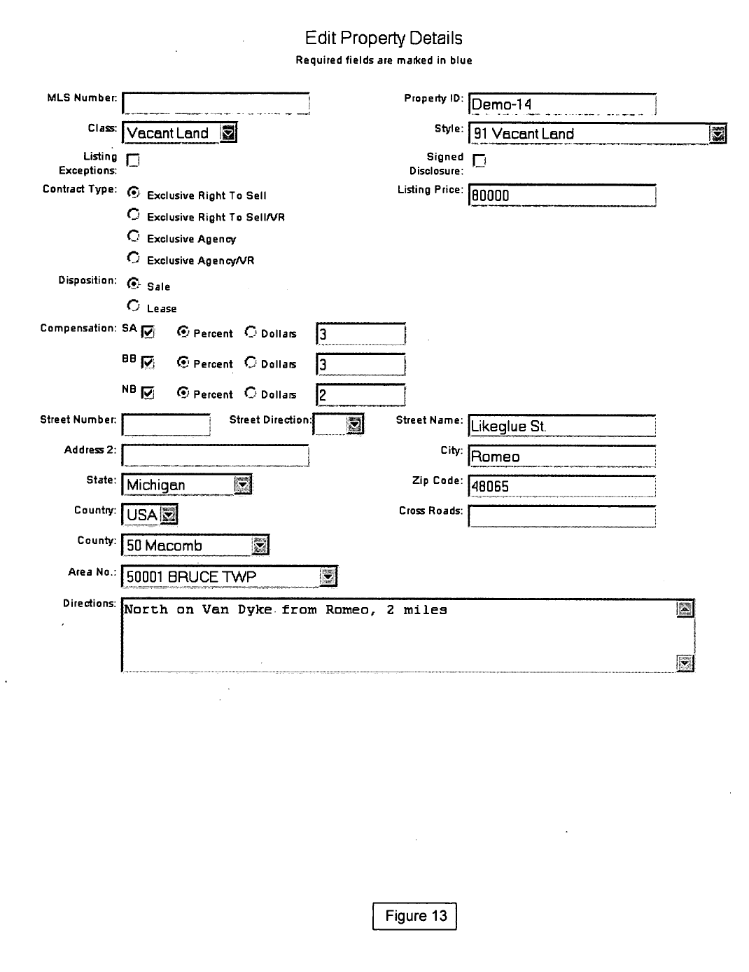

Referring now to FIG. 13, an exemplary web page for viewing and editing listing information is illustrated. The fields illustrated would be surrounded on the left and top sides by the navigation links as seen in FIG. 12. Several fields including MLS Number, Property ID, Listing Price, Street Number, Street Name, Address2, City, Zip Code, Cross Roads and Directions are included. Contact Type is a field for which only one selection can be made and is in the form of a radio button as is common in the art. Several fields including Class, Style, Street Direction, State, Country, County, and Area Number contain information from which a user must make one selection and are in the form of a drop-down list, as is common in the art.

Though not readily visible in FIG. 13, special relationships exist between some of the fields. In particular, special relationships exist between the Country, State, County, and Area Number fields. Selecting the Country limits the State selections, selecting the State limits the County selections, selecting the County limits the Area Number selections. The data that defines these relationships is incorporated into the system database, while the processing of these limitations has been incorporated within the ASP files in the web tier and the stored procedures in the business tier. Though not readily visible in FIG. 13, certain fields are required to be filled order to fulfill Exemplary business rules. From exemplary FIG. 13, these fields include Street Name, City, County, State, County, and Area Number. Data entered on this web page cannot be saved without those required fields being filled.

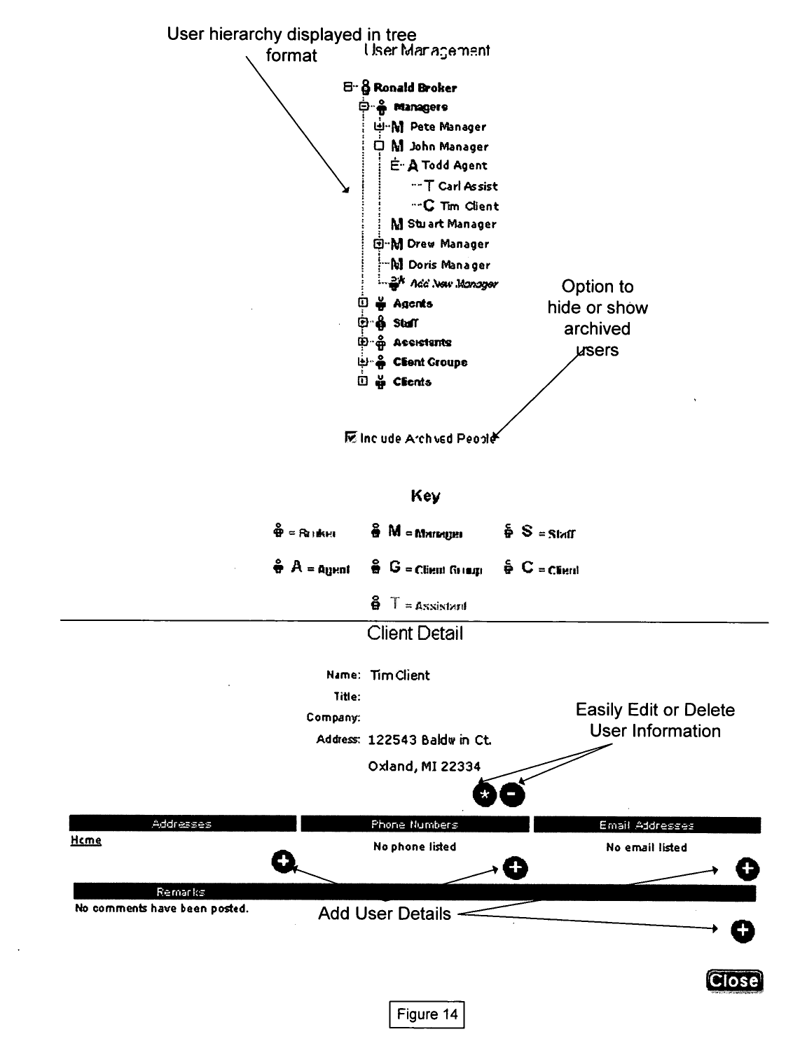

Referring to FIG. 14, an exemplary web page for viewing and editing user information is illustrated. In the upper portion of FIG. 14, the hierarchical relationship between a broker, managers, agents, assistants and clients is illustrated using a format called a tree structure, as is common in the art. Branches of the tree can be expanded and contracted as desired within the visual interface in order to display the desired data. Selecting a specific user within the tree structure causes a Client Detail web page to be displayed. From the Client Detail page all personal data about a user can be maintained including Name, Title, Addresses, Phone Numbers, and Email Addresses.

Although specific examples have been illustrated in FIG. 12, FIG. 13, and FIG. 14, it will be appreciated by those skilled in the art that variations or modifications thereto will achieve the desired results necessary to practice the present invention and as such is considered within the scope of the present invention.

XIV. Process Flowchart

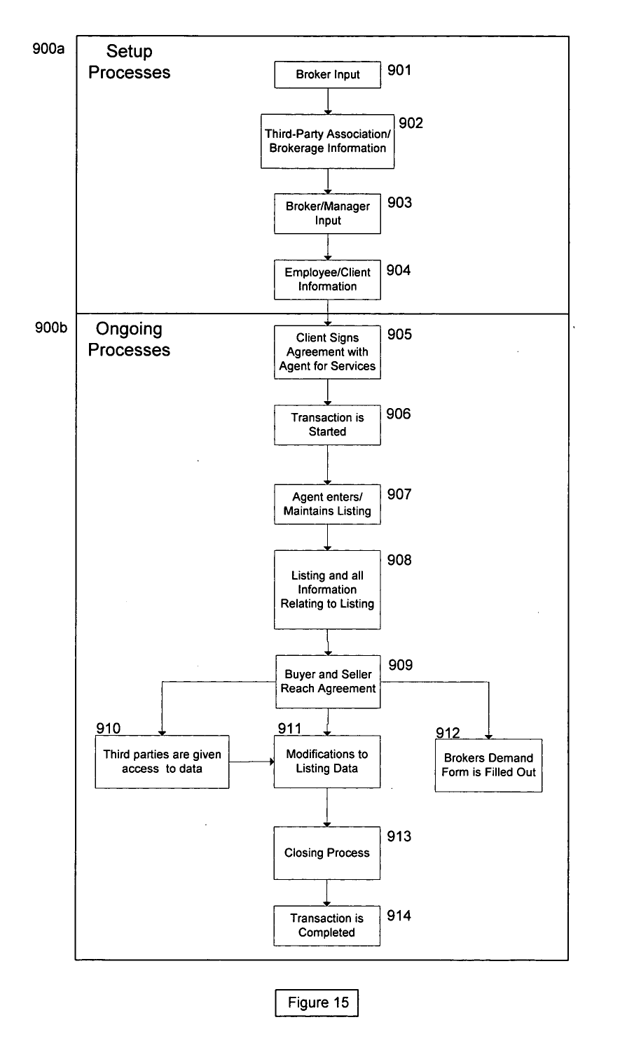

Referring to FIG. 15, there is illustrated a flowchart depicting different phases of a process for managing real estate transactions within a real estate company in accordance with an embodiment of the present invention. The Setup Processes 900a are generally done on an infrequent basis, while some portion of the Ongoing Processes 900b will often take place each day.

Referring to Step 901, a broker desires to use the present invention, where the system environment has been established by a separate entity. Information is gathered from the broker regarding the brokerage name, address, phone numbers, MLS affiliation, MLS system credentials, and the broker's name, address, phone numbers, and email addresses. A System Administrator enters this information into the present invention. This activates the brokerage in the present invention.

At Step 902, the broker can log into the present invention and can establish third-party company and contact associations for use throughout the brokerage. The broker can then proceed to Steps 903 and 904 to enter office managers, direct employees such as brokerage staff or direct-report agents, and broker clients. The broker should enter only those users that report directly to the broker or are the broker's direct clients.

Still referring to Steps 903 and 904, as managers are entered and granted login credentials to the present invention, they in turn can log into the present invention and enter those users that report directly to them (agents, staff, assistants), or their direct clients. As agents are entered and granted login credentials to the present invention, they in turn can log into the present invention and enter their assistants and clients. After the initial completion of these steps, the brokerage is considered to be set up and active in the present invention. Step 904 will continually be revisited as brokers, managers, and agents continue to obtain clients that are interested in either buying or selling property.

Referring now to Step 905, a client decides to use the services of a real estate company for the purpose of selling a property. An agreement is signed with the real estate company marking the start of a real estate transaction 906. After collecting the relevant property information, the property listing agent enters the property into the present invention 907. If the proper interfaces have been established, after a set amount of time dependent on business rules, the property listing is uploaded to the MLS system to which the brokerage is associated.

At Step 908, ongoing maintenance takes place on the property listing. Pictures are added, open houses and showings are scheduled, showing feedback is entered, the property listing is advertised and the advertisement information is entered into the present invention. The property listing may be advised to one or more clients of agents within the property listing brokerage. Documents will be added to the property listing including possibly a Seller's Disclosure and a Lead-Based Paint Disclosure. It is possible that the property never sells, and that the property listing expires and no further action is taken.

At Step 909, the buyer and seller reach an agreement and another phase of the real estate transaction is entered. The property listing agent associates various third-party contacts with the property listing 910. Title work, appraisals and surveys may be ordered. Several documents may be attached to the property listing. The status of the property listing is changed to Pending and Deal Data is entered. The Broker's Demand Form 912 is filled in. There may be further modifications to the property listing data 911 as the information comes together for setting up the closing. Because these changes are made in the database, any reports generated during this time will automatically reflect the most current information.

At Step 913, the closing process takes place. The property listing agent updates the property listing status to Closed, final data modifications are made to the property listing, and final documents are attached to the property listing. The property listing will now be included on any reports looking for closed listings where the property listing meets the other search criteria for the report.

At Step 914, the real estate transaction is complete. The property listing is still available for viewing and editing, though its status is Closed. At some point after the closing, the property listing and the client may be archived if desired.

The method of the present invention may be performed as a computer program and the various information, business rules, and the like may be stored in memory as a look-up table or the like. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the graphics display classes, their extensions, or document-producing programs on a CD ROM or via Internet download. In a sense, the Internet itself, as an abstract entity, is a computer readable medium. The same is true of computer networks in general. It is therefore to be understood that the method of the present invention may be performed by any electronic device capable of executing the above-described functions.

While the present invention has been described in terms of a limited number of embodiments, it is apparent that other forms could be adopted by one skilled in the art. In other words, claim elements are not limited to the imperfections of the exact language used, but encompass as well other structure that fulfills the same functional purpose. In other words, the teachings of the present invention encompass any reasonable substitutions or equivalents of claim limitations. Those skilled in the art will appreciate that other applications, including those outside of the real estate industry, are possible with this invention. Accordingly, the scope of the present invention is to be limited only by the following claims.

1. A method for automating at least some phases of real estate transfer, said method being centralized on at least one server and carried out over a distributed computer network to a plurality of client computers, said method comprising the steps of:
creating a real estate record on said at least one server;
receiving information from a plurality of sources including real estate databases, computer input devices, facsimile equipment, and electronic mail systems;
associating at least some of said information to said real estate record using a record identifier associated with said real estate record; and
storing said information on said at least one server in association with said real estate record.

2. The method as claimed in claim 1, wherein said receiving step includes receiving at least some portion of a property listing from a multiple listing service.

3. The method as claimed in claim 1, further comprising the step of transmitting at least a portion of said real estate record to a multiple listing service.

4. The method as claimed in claim 1, wherein said receiving step comprises:
receiving a fax communication from any fax source capable of contacting said at least one server irrespective of a fax number of said fax source;
prompting a sender of said fax communication to input said record identifier into said any fax source;
converting said fax communication into a digital document that represents said information to be associated and stored in accord with said associating and storing steps.

5. The method as claimed in claim 4, wherein said associating step comprises:
determining whether said record identifier matches any of a number of a plurality of real estate records; and
discarding said digital document if said determining step is negative.

6. The method as claimed in claim 5, wherein said storing step comprises saving said digital document on said at least one server in accord with a matching real estate record if said determining step is positive.

7. The method as claimed in claim 1, wherein said receiving step comprises:
receiving an email communication having said record identifier entered in a subject line of said email communication;
determining whether said record identifier matches any of a number of a plurality of real estate records;
discarding said email communication if said determining step is negative; and
saving an attachment associated with said email communication on said at least one server in accord with a matching real estate record if said determining step is positive.

8. The method as claimed in claim 1, wherein said receiving step includes a listing agent reviewing said information and granting view rights to authenticated users, such that said users can access and view a digital representation of said information.

9. The method as claimed in claim 8, wherein said receiving step further includes said listing agent marking said information as secured or unsecured.

10. The method as claimed in claim 1, further comprising the step of providing security clearance and access over said distributed computer network to at least some portions of said real estate record to a plurality of different users depending upon an assigned role of a user among said plurality of different users, said plurality of different users including buyers, sellers, brokers, managers, agents, financial entities, other third parties, or the like.

11. The method as claimed in claim 1, further comprising the step of providing a masquerade function whereby one of said plurality of different users can masquerade as another of said plurality of different users.

12. The method as claimed in claim 1, further comprising the step of tracking activity on said at least one server so as to provide an audit trail of said activity corresponding to said real estate record such as date of access, user identification, and the like.

13. The method as claimed in claim 1, wherein said method is administered by a real estate broker.

14. The method as claimed in claim 13, further comprising the step of said real estate broker controlling at least a portion of said information, said at least a portion of information including a list of third party companies with whom said real estate record is associated, such that a listing agent must use only third party companies from said list to conduct said real estate transfer.

15. The method as claimed in claim 13, further comprising the step of said real estate broker controlling at least a portion of said information, said at least a portion of said information including a scheduling master template.

16. The method as claimed in claim 15, further comprising the step of automatically generating a schedule for said real estate record from said scheduling master template.

17. The method as claimed in claim 16, wherein said generating step includes said schedule being automatically populated with a plurality of tasks and associated dates.

18. The method as claimed in claim 1, further comprising the step of automatically generating email communications to one or more of a plurality of users based on the happening of an event.

19. The method as claimed in claim 1, further comprising the step of automatically generating an email communication containing advertising information from said real estate record.

20. The method as claimed in claim 1, further comprising the step of generating reports from said real estate record.

21. A system for automating at least some phases of real estate transfers, said system comprising:
at least one server in a centralized location;
a distributed computer network in communication with said at least one server;
a plurality of client computers in communication with said distributed computer network;
means for creating a real estate record on said at least one server;
means for receiving information from a plurality of sources including real estate databases, computer input devices, facsimile equipment, and electronic mail systems;
means for associating at least some of said information to said real estate record using a record identifier associated with said real estate record; and
means for storing said information on said at least one server in association with said real estate record.

22. The system as claimed in claim 21, wherein said means for receiving includes means for receiving at least some portion of a property listing from a multiple listing service.

23. The system as claimed in claim 21, further comprising means for transmitting at least a portion of said real estate record to a multiple listing service.

24. The system as claimed in claim 21, wherein said means for receiving comprises:
means for receiving a fax communication from any fax source capable of contacting said at least one server irrespective of a fax number of said fax source;
means for prompting a sender of said fax communication to input said record identifier into said any fax source;
means for converting said fax communication into a digital document that represents said information to be associated and stored in accord with said means for associating and said means for storing.

25. The system as claimed in claim 24, wherein said means for associating comprises:
means for determining whether said record identifier matches any of a number of a plurality of real estate records; and
means for discarding said digital document if said means for determining is negative.

26. The system as claimed in claim 25, wherein said means for storing comprises means for saving said digital document on said at least one server in accord with a matching real estate record if said means for determining is positive.

27. The system as claimed in claim 21, wherein said means for receiving comprises:
means for receiving an email communication having said record identifier entered in a subject line of said email communication;
means for determining whether said record identifier matches any of a number of a plurality of real estate records;
means for discarding said email communication if said means for determining is negative; and
means for saving an attachment associated with said email communication on said at least one server in accord with a matching real estate record if said means for determining is positive.

28. The system as claimed in claim 21, wherein said means for receiving includes a listing agent reviewing said information and granting view rights to authenticated users, such that said users can access and view a digital representation of said information.

29. The system as claimed in claim 28, wherein said means for receiving further includes said listing agent marking said information as secured or unsecured.

30. The system as claimed in claim 21, further comprising means for providing security clearance and access over said distributed computer network to at least some portions of said real estate record to a plurality of different users depending upon an assigned role of a user among said plurality of different users, said plurality of different users including buyers, sellers, brokers, managers, agents, financial entities, other third parties, or the like.

31. The system as claimed in claim 21, further comprising means for providing a masquerade function whereby one of said plurality of different users can masquerade as another of said plurality of different users.

32. The system as claimed in claim 21, further comprising means for tracking activity on said at least one server so as to provide an audit trail of said activity corresponding to said real estate record such as date of access, user identification, and the like.

33. The system as claimed in claim 21, wherein said system is administered by a real estate broker.

34. The system as claimed in claim 33, further comprising means for controlling at least a portion of said information by said real estate broker, said at least a portion of information including a list of third party companies with whom said real estate record is associated, such that a listing agent must use only third party companies from said list to conduct said real estate transfer.

35. The system as claimed in claim 33, further comprising means for controlling at least a portion of said information by said real estate broker, said at least a portion of said information including a scheduling master template.

36. The system as claimed in claim 35, further comprising means for automatically generating a schedule for said real estate record from said scheduling master template.

37. The system as claimed in claim 36, wherein said means for generating includes said schedule being automatically populated with a plurality of tasks and associated dates.

38. The system as claimed in claim 21, further comprising means for automatically generating email communications to one or more of a plurality of users based on the happening of an event.

39. The system as claimed in claim 21, further comprising means for automatically generating an email communication containing advertising information from said real estate record.

40. The system as claimed in claim 21, further comprising means for generating reports from said real estate record.

41. A computer readable medium on which is stored computer program code, said computer program code implementing a method for automating at least some phases of real estate transfer, said method being centralized on at least one server and carried out over a distributed computer network to a plurality of client computers, said method comprising the steps of:
creating a real estate record on said at least one server;
receiving information from a plurality of sources including real estate databases, computer input devices, facsimile equipment, and electronic mail systems;
associating at least some of said information to said real estate record using a record identifier associated with said real estate record; and
storing said information on said at least one server in association with said real estate record.

42. The computer readable medium as claimed in claim 41, wherein said receiving step includes receiving at least some portion of a property listing from a multiple listing service.

43. The computer readable medium as claimed in claim 41, further comprising the step of transmitting at least a portion of said real estate record to a multiple listing service.

44. The computer readable medium as claimed in claim 41, wherein said receiving step comprises:
receiving a fax communication from any fax source capable of contacting said at least one server irrespective of a fax number of said fax source;
prompting a sender of said fax communication to input said record identifier into said any fax source;
converting said fax communication into a digital document that represents said information to be associated and stored in accord with said associating and storing steps.

45. The computer readable medium as claimed in claim 44, wherein said associating step comprises:
determining whether said record identifier matches any of a number of a plurality of real estate records; and
discarding said digital document if said determining step is negative.

46. The computer readable medium as claimed in claim 45, wherein said storing step comprises saving said digital document on said at least one server in accord with a matching real estate record if said determining step is positive.

47. The computer readable medium as claimed in claim 41, wherein said receiving step comprises:
receiving an email communication having said record identifier entered in a subject line of said email communication;
determining whether said record identifier matches any of a number of a plurality of real estate records;
discarding said email communication if said determining step is negative; and
saving an attachment associated with said email communication on said at least one server in accord with a matching real estate record if said determining step is positive.

48. The computer readable medium as claimed in claim 41, wherein said receiving step includes a listing agent reviewing said information and granting view rights to authenticated users, such that said users can access and view a digital representation of said information.

49. The computer readable medium as claimed in claim 48, wherein said receiving step further includes said listing agent marking said information as secured or unsecured.

50. The computer readable medium as claimed in claim 41, further comprising the step of providing security clearance and access over said distributed computer network to at least some portions of said real estate record to a plurality of different users depending upon an assigned role of a user among said plurality of different users, said plurality of different users including buyers, sellers, brokers, managers, agents, financial entities, other third parties, or the like.

51. The computer readable medium as claimed in claim 41, further comprising the step of providing a masquerade function whereby one of said plurality of different users can masquerade as another of said plurality of different users.

52. The computer readable medium as claimed in claim 41, further comprising the step of tracking activity on said at least one server so as to provide an audit trail of said activity corresponding to said real estate record such as date of access, user identification, and the like.

53. The computer readable medium as claimed in claim 41, wherein said computer readable medium is administered by a real estate broker.

54. The computer readable medium as claimed in claim 53, further comprising the step of said real estate broker controlling at least a portion of said information, said at least a portion of information including a list of third party companies with whom said real estate record is associated, such that a listing agent must use only third party companies from said list to conduct said real estate transfer.

55. The computer readable medium as claimed in claim 53, further comprising the step of said real estate broker controlling at least a portion of said information, said at least a portion of said information including a scheduling master template.

56. The computer readable medium as claimed in claim 55, further comprising the step of automatically generating a schedule for said real estate record from said scheduling master template.

57. The computer readable medium as claimed in claim 56, wherein said generating step includes said schedule being automatically populated with a plurality of tasks and associated dates.

58. The computer readable medium as claimed in claim 41, further comprising the step of automatically generating email communications to one or more of a plurality of users based on the happening of an event.

59. The computer readable medium as claimed in claim 41, further comprising the step of automatically generating an email communication containing advertising information from said real estate record.

60. The computer readable medium as claimed in claim 41, further comprising the step of generating reports from said real estate record.

61. A method for automating transfer of an electronic communication to a database, said method comprising the steps of:
creating a database record on at least one server, said database record having a record identifier associated therewith;
receiving information from at least one source including at least one of a facsimile generator and an electronic mail generator;
associating at least some of said information to said real estate record using said record identifier associated with said real estate record; and
storing said information on said at least one server in association with said real estate record.

62. The method as claimed in claim 61, wherein said receiving step comprises:
receiving a fax communication from any fax source capable of contacting said at least one server irrespective of a fax number of said fax source;
prompting a sender of said fax communication to input said record identifier into said any fax source;
converting said fax communication into a digital document that represents said information to be associated and stored in accord with said associating and storing steps.

63. The method as claimed in claim 62, wherein said associating step comprises:
determining whether said record identifier matches any of a number of a plurality of real estate records; and
discarding said digital document if said determining step is negative.

64. The method as claimed in claim 63, wherein said storing step comprises saving said digital document on said at least one server in accord with a matching real estate record if said determining step is positive.

65. The method as claimed in claim 61, wherein said receiving step comprises:
receiving an email communication having said record identifier entered in a subject line of said email communication;
determining whether said record identifier matches any of a number of a plurality of real estate records;
discarding said email communication if said determining step is negative; and
saving an attachment associated with said email communication on said at least one server in accord with a matching real estate record if said determining step is positive.

66. A system for automating transfer of an electronic communication to a database, said system comprising:
means for creating a database record on at least one server, said database record having a record identifier associated therewith;
means for receiving information from at least one source including at least one of a facsimile generator and an electronic mail generator;
means for associating at least some of said information to said real estate record using said record identifier associated with said real estate record; and
means for storing said information on said at least one server in association with said real estate record.

67. The method as claimed in claim 66, wherein said means for receiving comprises:
means for receiving a fax communication from any fax source capable of contacting said at least one server irrespective of a fax number of said fax source;
means for prompting a sender of said fax communication to input said record identifier into said any fax source;
means for converting said fax communication into a digital document that represents said information to be associated and stored in accord with said means for associating and said means for storing.

68. The method as claimed in claim 66, wherein said means for associating comprises:
means for determining whether said record identifier matches any of a number of a plurality of real estate records; and
means for discarding said digital document if said means for determining is negative.

69. The method as claimed in claim 68, wherein said means for storing comprises means for saving said digital document on said at least one server in accord with a matching real estate record if said means for determining is positive.

70. The method as claimed in claim 66, wherein said means for receiving comprises:
means for receiving an email communication having said record identifier entered in a subject line of said email communication;
means for determining whether said record identifier matches any of a number of a plurality of real estate records;
means for discarding said email communication if said means for determining is negative; and
means for saving an attachment associated with said email communication on said at least one server in accord with a matching real estate record if said means for determining is positive.

71. A computer readable medium on which is stored computer program code, said computer program code implementing a method for method for automating transfer of an electronic communication to a database, said method comprising the steps of:
creating a database record on at least one server, said database record having a record identifier associated therewith;
receiving information from at least one source including at least one of a facsimile generator and an electronic mail generator;
associating at least some of said information to said real estate record using said record identifier associated with said real estate record; and
storing said information on said at least one server in association with said real estate record.

72. The method as claimed in claim 71, wherein said receiving step comprises:
receiving a fax communication from any fax source capable of contacting said at least one server irrespective of a fax number of said fax source;
prompting a sender of said fax communication to input said record identifier into said any fax source;
converting said fax communication into a digital document that represents said information to be associated and stored in accord with said associating and storing steps.

73. The method as claimed in claim 72, wherein said associating step comprises:
determining whether said record identifier matches any of a number of a plurality of real estate records; and
discarding said digital document if said determining step is negative.

74. The method as claimed in claim 73, wherein said storing step comprises saving said digital document on said at least one server in accord with a matching real estate record if said determining step is positive.

75. The method as claimed in claim 71, wherein said receiving step comprises:
receiving an email communication having said record identifier entered in a subject line of said email communication;
determining whether said record identifier matches any of a number of a plurality of real estate records;
discarding said email communication if said determining step is negative; and
saving an attachment associated with said email communication on said at least one server in accord with a matching real estate record if said determining step is positive.
